(19) United States
(12) Patent Application Publication
(10) Pub. No.: US 2025/0324412 A1
(43) Pub. Date: Oct. 16, 2025

(54) METHODS FOR DETERMINING IDLE OCCASION, APPARATUS AND STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/247,807

(22) Filed: Jun. 24, 2025

Related U.S. Application Data
(63) Continuation of application No. PCT/CN2022/142083, filed on Dec. 26, 2022.

(51) Int. Cl. H04W 72/115; H04W 72/21

(52) U.S. Cl. CPC H04W 72/115; H04W 72/21

(57) ABSTRACT

Methods for determining an idle occasion, an apparatus and a storage medium. The method includes: receiving first signaling sent by a base station, the first signaling being used to indicate at least one uplink grant-free transmission resource on a bandwidth part configured by the base station for the terminal; and according to idleness information, determining an idle occasion released from a transmission occasion of the at least one uplink grant-free transmission resource. The idle occasion is for reuse by the base station.

### CROSS-REFERENCE TO RELATED APPLICATION(S)

This application is a continuation application of International Application No. PCT/CN2022/142083, filed Dec. 26, 2022, the entire disclosure of which is incorporated herein by reference.

### TECHNICAL FIELD

The present disclosure relates to the field of communications, and in particular to a method and apparatus for determining an idle occasion and a storage medium.

### BACKGROUND

In related art, regarding uplink grant-free transmission, it has been determined that unused uplink grant-free transmission occasion(s) needs (need) to be reused. However, how to reliably and effectively reuse the transmission occasion(s) is an urgent problem to be solved.

### SUMMARY

According to a first aspect of an embodiment of the present disclosure, a method for determining an idle occasion is provided. The method is performed by a terminal, and the method includes:
receiving first signaling sent by a base station, wherein the first signaling is used to indicate at least one uplink grant-free transmission resource on a bandwidth part configured by the base station for the terminal; and
according to idleness information, determining an idle occasion released from a transmission occasion of the at least one uplink grant-free transmission resource, wherein the idle occasion is for reuse by the base station.

According to a second aspect of an embodiment of the present disclosure, a method for determining an idle occasion is provided. The method is performed by a base station, and the method includes:
sending first signaling to a terminal, wherein the first signaling is used to indicate at least one uplink grant-free transmission resource on a bandwidth part configured by the base station for the terminal; and
according to idleness information, determining an idle occasion released by the terminal from a transmission occasion of the at least one uplink grant-free transmission resource, wherein the idle occasion is for reuse by the base station.

According to a third aspect of an embodiment of the present disclosure, a terminal is provided. The terminal includes:
a receiving module configured to receive first signaling sent by a base station, wherein the first signaling is used to indicate at least one uplink grant-free transmission resource on a bandwidth part configured by the base station for the terminal; and
a processing module configured to, according to idleness information, determine an idle occasion released from a transmission occasion of the at least one uplink grant-free transmission resource, wherein the idle occasion is for reuse by the base station.

According to a fourth aspect of an embodiment of the present disclosure, a base station is provided. The base station includes:
a sending module configured to send first signaling to a terminal, wherein the first signaling is used to indicate at least one uplink grant-free transmission resource on a bandwidth part configured by the base station for the terminal; and
a processing module configured to, according to idleness information, determine an idle occasion released by the terminal from a transmission occasion of the at least one uplink grant-free transmission resource, wherein the idle occasion is for reuse by the base station.

According to a fifth aspect of an embodiment of the present disclosure, a communication apparatus is provided. The apparatus includes:
a processor; and
a memory configured to store instructions executable by the processor;
wherein the processor is configured to:
perform the method as described in the first aspect of the present disclosure, or perform the method as described in the second aspect of the present disclosure.

According to a sixth aspect of an embodiment of the present disclosure, a non-transitory computer-readable storage medium is provided. Computer program instructions are stored on the non-transitory computer-readable storage medium. When the program instructions are executed by a processor, steps of the method described in the first aspect of the present disclosure are implemented, or steps of the method described in the second aspect of the present disclosure are implemented.

According to a seventh aspect of an embodiment of the present disclosure, a communication system is provided. The communication system includes:
a base station configured to perform the method as described in the first aspect of the present disclosure; and
a terminal configured to perform the method as described in the second aspect of the present disclosure.

It is to be understood that the foregoing general description and the following detailed description are illustrative and explanatory only and are not restrictive of the present disclosure.

### BRIEF DESCRIPTION OF THE DRAWINGS

The above and/or additional aspects and advantages of the present disclosure will become apparent and easily understood from the following description of the embodiments in conjunction with the accompanying drawings, in which:

FIG. 1A illustratively shows a schematic diagram of a system architecture applicable to an embodiment of the present disclosure.

FIG. 1B illustratively shows a schematic diagram of a 5G system architecture.

FIG. 2 is a flowchart of a method for determining an idle occasion according to an example embodiment.

FIG. 3 is a flowchart of a method for determining an idle occasion according to an example embodiment.

FIG. 4 is a flowchart of a method for determining an idle occasion according to an example embodiment.

FIG. 5 is a flowchart of a method for determining an idle occasion according to an example embodiment.

FIG. 6 is a flowchart of a method for determining an idle occasion according to an example embodiment.

FIG. 7 is a flowchart of a method for determining an idle occasion according to an example embodiment.

FIG. 8 is a flowchart of a method for determining an idle occasion according to an example embodiment.

FIG. 9 is a flowchart of a method for determining an idle occasion according to an example embodiment.

FIG. 10 is a flowchart of a method for determining an idle occasion according to an example embodiment.

FIG. 11 is a flowchart of a method for determining an idle occasion according to an example embodiment.

FIG. 12 is a flowchart of a method for determining an idle occasion according to an example embodiment.

FIG. 13 is a block diagram of a terminal according to an example embodiment.

FIG. 14 is a block diagram of a base station according to an example embodiment.

FIG. 15 is a block diagram of a communication apparatus according to an example embodiment.

FIG. 16 is a block diagram of a communication apparatus according to an example embodiment.

### DETAILED DESCRIPTION

Example embodiments will be described in detail herein, examples of which are shown in the accompanying drawings. When the following description refers to the drawings, the same numbers in different drawings represent the same or similar elements unless otherwise indicated. The implementations described in the following example embodiments do not represent all implementations consistent with the present disclosure. Instead, they are merely examples of apparatuses and methods consistent with some aspects of the present disclosure as detailed in the appended claims.

First, relevant technologies are introduced in the present disclosure.

For uplink grant-free transmission, Physical Uplink Shared Channel Transmission with a Configured Grant (PUSCH Transmission with a Configured Grant) was introduced in R15. Transmissions based on Configured Grant (CG) resources belong to the category of uplink grant-free (GF) transmission. When a terminal device has uplink data to send, the terminal device may directly use a CG resource to send data to an access network device, and does not need to receive a dynamic grant of the access network device, and does not need to send a preamble.

The R15 version supports two types of uplink grant-free transmission. All parameters of the first type of grant-free transmission are configured by a base station through higher layer signaling; a part of parameters of the second type of grant-free transmission are configured by the base station through higher layer signaling, and other scheduling-related parameters are configured by the base station through an activating Downlink Control Information (DCI). R16 supports configuration and activation of up to 12 sets of uplink grant-free transmission configurations on a Bandwidth Part (BWP), and each set of configurations is identified by an index.

Currently, the period of uplink grant-free transmission is configured by higher layer signaling, supporting up to 14*40960 symbols. Within the period, for the first type of grant-free transmission, time-frequency resource(s) (that is, CG resource(s)) is (are) configured through higher layer signaling, and for the second type of grant-free transmission, time-frequency resource(s) is (are) configured by an activating DCI; the time-frequency resource(s) within the period may include a plurality of uplink grant-free transmission occasions, that is, CG PUSCH occasions (physical uplink shared channel occasions with a configured grant).

In the related art, regarding uplink grant-free transmission, it has been determined that unused uplink grant-free transmission occasion(s) needs (need) to be reused. However, how to reliably and effectively reuse the transmission occasion(s) is an urgent problem to be solved.

In order to solve the problems existing in the related art, the present disclosure provides a method and apparatus for determining an idle occasion and a storage medium.

The following first introduces an implementation environment of embodiments of the present disclosure:

Embodiments of the present disclosure may be applicable to a communication system, for example, a fourth generation mobile communication system (4G) evolution system, such as the Long Term Evolution (LTE) system, or may also be applicable to a fifth generation mobile communication system (5G) system, such as access network using new radio access technology (New RAT); Cloud Radio Access Network (CRAN), etc.

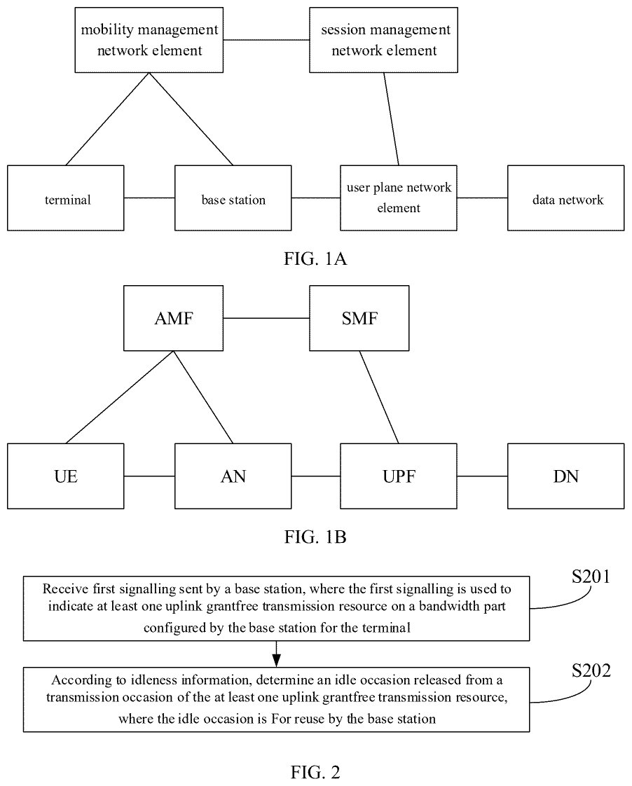

FIG. 1A illustratively shows a schematic diagram of a system architecture applicable to an embodiment of the present disclosure. It should be understood that the embodiments of the present disclosure are not limited to the system shown in FIG. 1A. In addition, the apparatuses in FIG. 1A may be hardware, or software divided in terms of function, or a structure that is a combination of the two. As shown in FIG. 1A, the system architecture provided by the embodiment of the present disclosure includes a terminal, a base station, a mobility management network element, a session management network element, a user plane network element, and a Data Network (DN). The terminal communicates with the DN through the base station and the user plane network element.

The network elements shown in FIG. 1A may be network elements in a 4G architecture or network elements in a 5G architecture.

The Data Network (DN) provides data transmission services for users and may be a Protocol Data Unit (PDN) network, such as the Internet, IP Multimedia Service (IMS), etc.

Referring to a 5G system architecture diagram shown in FIG. 1B, the mobility management network element may include an access and mobility management entity (Access and mobility Management Function, AMF) in 5G. The mobility management network element is responsible for access and mobility management of terminals in a mobile network. The AMF is responsible for terminal access and mobility management, NAS message routing, Session Management Function (SMF) selection, etc. The AMF may be used as an intermediate network element to transmit session management messages between a terminal and a SMF.

The session management network element is responsible for forwarding path management, such as sending packet forwarding policies to the user plane network element, indicating the user plane network element to process and forward packets according to the packet forwarding policies. The session management network element may be the SMF in 5G (as shown in FIG. 1B), which is responsible for session management, such as session creation/modification/deletion, user plane network element selection, and allocation and management of user plane tunnel information, etc.

The user plane network element may be a User Plane Function (UPF) in the 5G architecture, as shown in FIG. 1B. The UPF is responsible for packet processing and forwarding.

The system architecture provided by the embodiment of the present disclosure may further include a data management network element for processing terminal device identities, access authentication, registration and mobility management, etc. In a 5G communication system, the data management network element may be a Unified Data Management (UDM) network element.

The system architecture provided by the embodiment of the present disclosure may further include a policy control function entity (Policy Control Function (PCF) or a policy and charging control function entity (Policy and Charging Control Function, PCRF). The PCF or PCRF is responsible for policy control decision-making and traffic-based charging control.

The system architecture provided by the embodiment of the present disclosure may further include a network storage network element for maintaining real-time information of all network function services in the network. In the 5G communication system, the network storage network element may be a Network Repository Function (NRF) network element. Information of a lot of network elements may be stored in the network repository network element, such as information of the SMF, information of the UPF, information of the AMF, etc. The network elements such as AMF, SMF, UPF in the network may be connected to the NRF. On the one hand, the network elements may register their own network element information to the NRF, and on the other hand, other network elements may obtain registered information of network elements from the NRF. Other network elements (such as AMF) may obtain network elements to be selected by requesting the NRF based on a network element type, a data network identity, unknown area information, etc. If a Domain Name System (DNS) server is integrated in the NRF, a corresponding selection function network element (such as AMF) may request the NRF to obtain other network elements to be selected (such as SMFs).

As a specific implementation form of an Access Network (AN), a base station may also be called an access node. If it is a form of wireless access, the access network is called a Radio Access Network (RAN), as shown in FIG. 1B, providing wireless access services for terminals. The access node may be a base station in a Global System for Mobile communication (GSM) system or a Code Division Multiple Access (CDMA) system, a base station (NodeB) in a Wideband Code Division Multiple Access (WCDMA) system, or the access node may be an evolutional base station (evolutional node B, eNB or eNodeB) in an LTE system, or a base station device in a 5G network, a small base station device, a wireless access node (WiFiAP), a wireless interoperability for microwave access base station (WiMAX BS), etc., and the present disclosure does not limit this.

The terminal may also be referred to as an access terminal, User Equipment (UE), a user unit, a user station, a mobile, a mobile station, a remote station, a remote terminal, a mobile device, a user terminal, a wireless communication device, a user agent or a user device, etc. FIG. 1B is illustrated by taking UE as an example. The terminal may be a cellular phone, a cordless phone, a Session Initiation Protocol (SIP) phone, a Wireless Local Loop (WLL) station, a Personal Digital Assistant (PDA), a handheld device with a wireless communication capability, a computing device or other processing device connected to a wireless modem, a vehicle-mounted device, a wearable device, an Internet of Things terminal device, such as a fire detection sensor, a smart water meter/electricity meter, a factory monitoring device, etc.

The above functions may be network elements in hardware devices, software functions running on dedicated hardware, or virtualized functions instantiated on a platform (e.g., a cloud platform).

In the above communication system architecture, the base station and the terminal may be used to perform steps mentioned in the following method embodiments, respectively.

FIG. 2 is a flowchart of a method for determining an idle occasion according to an example embodiment. The method is performed by a terminal. As shown in FIG. 2, the method includes:

In S201, first signaling sent by a base station is received. The first signaling is used to indicate at least one uplink grant-free transmission resource on a bandwidth part configured by the base station for the terminal.

An uplink grant-free transmission resource may be a CG resource. The base station may send a CG resource configuration indication through the first signaling to indicate the uplink grant-free transmission resource(s) configured for the terminal.

In S202, according to idleness information, an idle occasion released from a transmission occasion of the at least one uplink grant-free transmission resource is determined. The idle occasion is for reuse by the base station.

An idle occasion is an idle CG PUSCH occasion. The idleness information may be used to indicate an idle occasion in the uplink grant-free transmission resource(s) that can be released by the terminal, and/or a non-idle occasion used by the terminal for an uplink transmission.

It can be understood that after receiving the uplink grant-free transmission resource(s) configured by the base station for the terminal, the terminal can perform an uplink transmission in a non-idle grant-free uplink transmission occasion in the uplink grant-free transmission resource(s). At the same time, based on the idleness information, the idle occasion(s) to be released by the terminal is (are) determined, so that the base station can reuse the idle occasion(s).

The first signaling may be single signaling, or a collective name for a plurality of pieces of signaling. For example, the first signaling may be single Radio Resource Control (RRC) signaling, or may be formed by one piece of RRC signaling and one or more pieces of dynamic signaling. The dynamic signaling may carry Downlink Control Information (DCI), for example. In a possible implementation, the idleness information may be carried by the first signaling to save signaling. For example, the base station may carry downlink control information through dynamic signaling, and the downlink control information may carry the idleness information determined by the base station. Alternatively, the signaling carrying the idleness information is separate single signaling, which is not limited in the present disclosure.

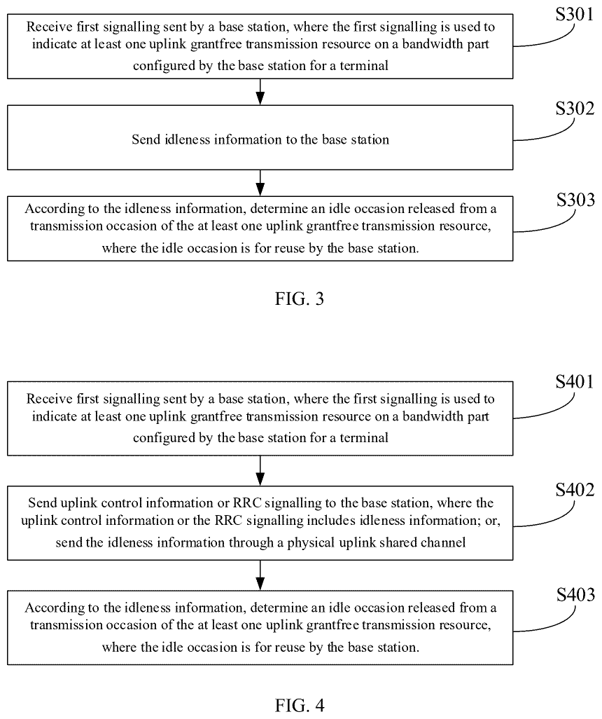

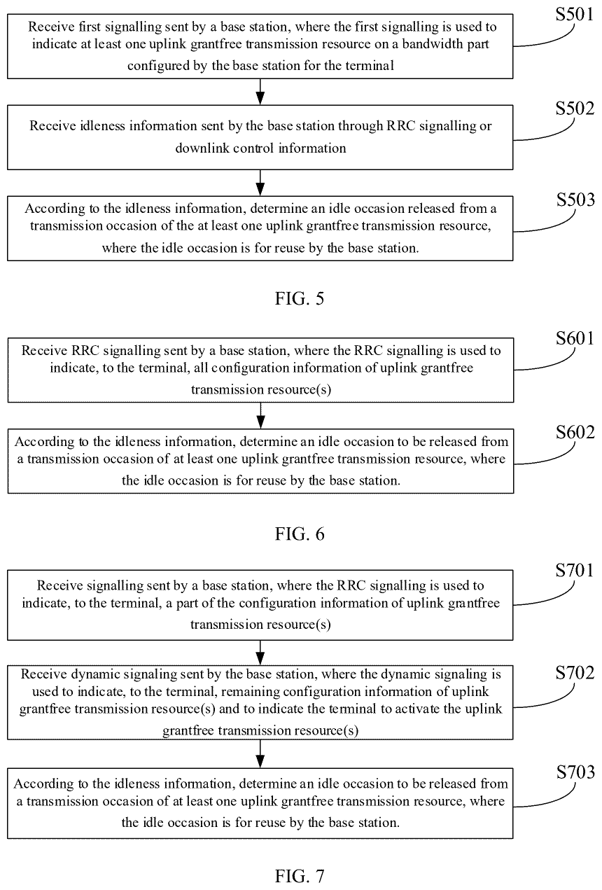

In addition, the idleness information may be determined by the terminal, that is, the terminal determines the idle occasion(s) to be released by the terminal and notifies the base station of the idle occasion(s) to reuse the idle occasion(s), such as the embodiments shown in FIG. 3 or FIG. 4. Alternatively, the idleness information may be determined by the base station, and the base station indicates the terminal to release the idle occasion(s), so as to ensure that the base station can reliably reuse the idle occasion(s), such as the embodiment shown in FIG. 5. The specific implementations will be introduced in the following embodiments and will not be described in detail here.

One piece of idleness information may correspond to one uplink grant-free transmission resource. That is, one piece of idleness information may be used to indicate an idle occasion in one uplink grant-free transmission resource. If the base station configures a plurality of uplink grant-free transmission resources for the terminal in a bandwidth part, the idle occasion in each uplink grant-free transmission resource may be determined based on a plurality of pieces of idleness information. Alternatively, one piece of idleness information may correspond to a plurality of uplink grant-free transmission resources. That is, one piece of idleness information may be used to indicate idle occasion(s) in a plurality of uplink grant-free transmission resources.

In an example, the idleness information includes an occasion indication field, and the occasion indication field is used to indicate the number M of idle occasion(s) in transmission occasion(s). The number M is an integer greater than or equal to zero.

For example, the method in which the occasion indication field indicates the number M of idle occasion(s) may be as shown in Tables 1 to 3 below. Those skilled in the art may configure the occasion indication field based on at least one of the methods 1 to 5 in any of the following tables:

TABLE 1

| Number of bits | | | | | | |
|---|---|---|---|---|---|---|
| in the occasion | | | | | | |
| indication field | Bit | Method | Method | Method | Method | Method |
| (N) | value | 1 | 2 | 3 | 4 | 5 |
| 2 | 00 | 0 | 1 | 0 | 1 | 2 |
| | 01 | 1 | 2 | 2 | 2 | 4 |
| | 10 | 2 | 3 | 4 | 4 | 8 |
| | 11 | 3 | 4 | 8 | 8 | 16 |

TABLE 2

| Number of bits | | | | | | |
|---|---|---|---|---|---|---|
| in the occasion | | | | | | |
| indication field | Bit | Method | Method | Method | Method | Method |
| (N) | value | 1 | 2 | 3 | 4 | 5 |
| 1 | 0 | 0 | 0 | 1 | 2 | 4 |
| | 1 | all | 1 | 2 | 4 | 8 |

TABLE 3

| Number of bits | | | | | | |
|---|---|---|---|---|---|---|
| in the occasion | | | | | | |
| indication field | Bit | Method | Method | Method | Method | Method |
| (N) | value | 1 | 2 | 3 | 4 | 5 |
| 3 | 000 | 0 | 1 | 0 | 2 | 0 |
| | 001 | 1 | 2 | 2 | 4 | 2 |
| | 010 | 2 | 3 | 4 | 6 | 4 |
| | 011 | 3 | 4 | 6 | 8 | 8 |
| | 100 | 4 | 5 | 8 | 10 | 16 |
| | 101 | 5 | 6 | 10 | 12 | 32 |
| | 110 | 6 | 7 | 12 | 14 | 64 |
| | 111 | 7 | 8 | 14 | 16 | 128 |

As shown in Table 1, the occasion indication field may include N bits, where Nis an integer greater than zero. The index value corresponding to the decimal number indicated by the N bits may be used to indicate the number M.

Taking the case where the number of bits in the occasion indication field is 2 as an example, the occasion indication field may have bit values 00, 01, 10, and 11, corresponding to index value 0, 1, 2, and 3.

In an implementation, when the index value is 0, it may correspond to the number M of 0. When the index value is 1, it may correspond to the number M of 1. When the index value is 2, it may correspond to the number M of 2. When the index value is 3, it may correspond to the number M of 3. In another implementation, when the index value is 0, it may correspond to the number M of 1. When the index value is 1, it may correspond to the number M of 2. When the index value is 2, it may correspond to the number M of 3. When the index value is 3, it may correspond to the number M of 4. In another implementation, when the index value is 0, it may correspond to the number M of 0 or 1. When the index value is 1, it may correspond to the number M of the first power of 2. When the index value is 2, it may correspond to the number M of the second power of 2 (i.e., 4). When the index value is 3, it may correspond to the number M of the third power of 2 (i.e., 8). In another implementation, when the index value is 0, it may correspond to the number M of 2. When the index value is 1, it may correspond to the number M of 4. When the index value is 2, it may correspond to the number M of 8. When the index value is 3, it may correspond to the number M of 16, and so on. Those skilled in the art may calibrate the number M corresponding to each index value according to actual needs, and the present disclosure does not make any specific limitation on this.

Table 2 is similar to Table 3. When the number of bit(s) in the occasion indication field is 1, 3 or more, the number M corresponding to the occasion indication field follows a similar principle and will not be repeated here.

Optionally, in this example:
the occasion indication field is used to indicate that M transmission occasion(s) after signaling carrying the idleness information is sent is (are) idle occasion(s); or
the occasion indication field is used to indicate that the first M transmission occasion(s) in an idleness window is (are) idle occasion(s); or
the occasion indication field is used to indicate that the last M transmission occasion(s) in the idleness window is (are) idle occasion(s); or
the occasion indication field is used to indicate that M transmission occasion(s) after a preset time length after the signaling carrying the idleness information is sent is (are) idle occasion(s);
the idleness window corresponds to a time domain resource and/or a frequency domain resource, and the candidate preset time length corresponds to a time domain resource.

It can be understood that the signaling carrying the idleness information when the idleness information is determined by the terminal is different from the signaling carrying the idleness information when the idleness information is determined by the base station.

In addition, the idleness window may be used to indicate a time range. The idleness window may be described by the number of symbols, the number of slots, or a time length. For example, the time length may be 50 microseconds or 500 microseconds. The preset time length may be an absolute time length, such as 500 milliseconds or 1000 milliseconds.

It is worth noting that the idleness window may be an independent time domain concept or a time-frequency domain concept. When the idleness window is the time-frequency domain concept, the idleness window may occupy one or more Radio Bearers (RBs), or a carrier, or a band, or a BWP, etc. in the frequency domain, and the present disclosure does not limit this.

In addition, the idleness window and the preset time length may be indicated by the base station, or may be notified to the base station by the terminal, or may be configured to the terminal by the base station through higher layer signaling. How to make the base station and the terminal reach a consensus on the idleness window and the preset time length will be further introduced in the following embodiments and will not be elaborated here.

In another example, the idleness information includes the idleness window and the occasion indication field. The occasion indication field includes N bits, and each bit is used to indicate whether a corresponding transmission occasion in the idleness window is idle.

The idleness information may specifically include information about the number of idleness window(s), time information of the idleness window(s), such as the number of symbols or the number of slots, and/or information about the number of transmission occasion(s) in the idleness window(s), etc. The idleness information may include one or more idleness windows.

For example, if the idleness information indicates that there are 10 idleness windows in the current uplink grant-free transmission resource(s), if the occasion indication field includes 10 bits, when any one bit is 1, it may indicate that the transmission occasion(s) in the idleness window corresponding to the bit is (are) idle occasion(s); when any one bit is 0, it can indicate that the transmission occasion(s) in the idleness window corresponding to the bit is (are) non-idle occasion(s).

In an example, the idleness window includes N idleness sub-window(s), and each of the N bits is further used to indicate whether transmission occasion(s) in the idleness sub-window is (are) idle.

For example, if the length of an idleness window is W (W may be the number of symbols or the number of slots), the idleness window may be divided into N idleness sub-window(s). Specifically, the granularity of the first ┌W/N┐*N−W idleness sub-windows is └W/N┘, and the granularity of the last N+W−┌W/N┐*N idleness sub-windows is ┌W/N┐. Alternatively, the granularity of the first W−└W/N┘*N idleness sub-windows is ┌W/N┐, and the granularity of the last N−W+┌W/N┐*N idleness sub-windows is └W/N┘.

For example, if the length of an idleness window is 20 symbols and the occasion indication field includes 8 bits, the idleness window may be divided as follows: the granularity of the first 4 idleness sub-windows is 2 symbols and the granularity of the last 4 idleness sub-windows is 3 symbols. If any one bit in the occasion indication field is 1, it may indicate that the transmission occasion(s) in the idleness sub-window corresponding to the bit is (are) idle occasion(s). If any one bit is 0, it may indicate that the transmission occasion(s) in the idleness sub-window corresponding to the bit is (are) non-idle occasion(s). For example, if the occasion indication field is 00001111, the idleness information may indicate that the transmission occasions in the first 8 symbols in the idleness window are non-idle occasions, and the transmission occasions in the last 12 symbols are all idle occasions.

In another example, the transmission occasion(s) in the idleness window includes (include) N transmission occasion group(s), and each of the N bits is further used to indicate whether a transmission occasion group is idle.

For example, if the idleness window includes W transmission occasions, the plurality of transmission occasions in the idleness window are divided into N transmission occasion groups. Specifically, the granularity of the first ┌W/N┐*N−W transmission occasion groups is └W/N┘, and the granularity of the last N+W−┌W/N┐*N transmission occasion groups is ┌W/N┐. Alternatively, the granularity of the first W−└W/N┘*N transmission occasion groups is ┌W/N┐, and the granularity of the last N−W+┌W/N┐*N transmission occasion groups is └W/N┘.

In the embodiment, ┌W/N┐ means that the value of W divided by N is rounded up, and └W/N┘ means that the value of W divided by N is rounded down.

For example, if the number of transmission occasions is 20, and the occasion indication field includes 8 bits, the plurality of transmission occasions may be divided, and the granularity of the first 4 transmission occasion groups is 2 transmission occasions, and the granularity of the last 4 transmission occasion groups is 3 transmission occasions. If any one bit in the occasion indication field is 1, it may indicate that the transmission occasion(s) in the transmission occasion group corresponding to the bit is (are) idle occasion(s). When any one bit is 0, it may indicate that the transmission occasion(s) of the transmission occasion group corresponding to the bit is (are) non-idle occasion(s). For example, if the occasion indication field is 00001111, the idleness information may indicate that the first 4*2 transmission occasions in the idleness window are non-idle occasions, and the last 4*3 transmission occasions are all idle occasions.

In yet another example, the idleness information includes an occasion indication granularity and an occasion indication field;
the occasion indication granularity is used to indicate a time period, where the time period is indicated by the number of symbols, or by the number of slots, or by a time length;
the occasion indication field includes N bits, and each bit is used to indicate whether transmission occasion(s) within an occasion indication granularity is (are) idle.

The starting time of a time period indicated by the first bit of the occasion indication field may be a time point when sending of the signaling carrying the idleness information ends, or the first symbol after the last time domain symbol of the signaling carrying the idleness information, or the first slot after a slot where the last time domain symbol of the signaling carrying the idleness information is located.

For example, in a case where the time period indicated by the occasion indication granularity is 2 symbols and the occasion indication field includes 8 bits, if the occasion indication field is 00001111, the idleness information may indicate that all transmission occasions in the first 4*2 symbols are non-idle occasions, and all transmission occasions in the last 4*2 symbols are idle occasions.

In yet another example, the idleness information includes an idleness window, and the idleness window is used to indicate that all transmission occasions within the idleness window are idle occasions.

For example, the length of the idleness window is 20 symbols, and all transmission occasions within the 20 symbols are idle occasions.

In another example, the idleness information includes the occasion indication field, the occasion indication field includes N bits, and each bit is used to indicate whether a transmission occasion in an uplink grant-free transmission resource corresponding to the bit in the at least one uplink grant-free transmission resource is idle.

For example, if the base station configures 8 sets of uplink grant-free transmission resources for the terminal, the occasion indication field may include 8 bits. If the occasion indication field is 00001111, it may indicate that the transmission occasions in the first 4 sets of uplink grant-free transmission resources are non-idle occasions, and the transmission occasions in the last 4 sets of uplink grant-free transmission resources are all idle occasions.

In an example, the idleness window does not include at least one of the following:
a downlink resource used for downlink data transmission; a flexible resource that is not configured with an uplink or downlink data transmission attribute; a resource occupied for transmitting a Synchronization Signal (SS) and Physical Broadcast Channel (PBCH); a resource occupied by data transmitted through a Physical Downlink Shared Channel (PDSCH); a resource occupied for transmitting Channel State Information (CSI); a resource occupied for transmitting a Sounding Reference Signal (SRS); a resource occupied by data transmitted through a Physical Downlink Control Channel (PDCCH).

The above-mentioned resources may include frequency domain resources and/or time domain resources. For example, a downlink resource may include a downlink time domain symbol and a downlink slot in the time domain. In addition, whether a time domain symbol in a flexible resource is an uplink symbol or a downlink symbol may be indicated by a Service Feature Instance (SFI).

The synchronization signal and the physical broadcast channel may be combined into a synchronization signal and physical broadcast channel block, namely, SS/PBCH block, which may be formed by three parts: Primary Synchronization Signals (PSS), Secondary Synchronization Signals (SSS), Physical Broadcast Channel (PBCH). Specifically, the idleness window skips at least one of the above-mentioned time domain and/or frequency domain resources. In other words, when determining the idleness window, the base station or terminal needs to skip the above-mentioned time domain and/or frequency domain resources. This can avoid a situation where transmission occasion(s) in an idleness window is (are) non-idle occasion(s).

In an example, the idleness window is any one of the following:
a preset time length after a time point when sending of the signaling carrying the idleness information ends; a time domain resource corresponding to X consecutive time domain symbol(s) after the last time domain symbol of the signaling carrying the idleness information; a time domain resource corresponding to Y consecutive slot(s) after a slot where the last time domain symbol of the signaling carrying idleness information is located; a frequency domain resource corresponding to the preset time length after the time point when sending of the signaling carrying the idleness information ends; a frequency domain resource corresponding to the X consecutive time domain symbol(s) after the last time domain symbol of the signaling carrying idleness information; a frequency domain resource corresponding to the Y consecutive slot(s) after the slot where the last time domain symbol of the signaling carrying idleness information is located. In a possible implementation, after the base station or the terminal determines that the idleness window is any one of the above, the resource(s) not included in the above idleness window may be skipped from the determined idleness window. For example, if the idleness window is determined to be a resource corresponding to 14 consecutive time domain symbols after the last time domain symbol of the signaling carrying the idleness information but 4 of these 14 symbols are downlink symbols occupied by SS/PBCH, both the terminal and the base station may skip the 4 downlink symbols in this case, and determine that the idleness window is the resource corresponding to the other 10 symbols.

In the embodiments, X and Y are both integers greater than zero. Specifically, the above-mentioned preset time length and X, Y may be determined according to actual needs or a capability of the terminal, and the present disclosure does not limit their specific values. In addition, for example, if the time point when sending of the signaling carrying idleness information ends is taken as the 0th millisecond, the idleness window may be the 1st to 100th millisecond. That is, the idleness window may be a preset time length with the time point when sending of the signaling carrying the idleness information ends as the starting time; the starting symbol of the above-mentioned X time domain symbol(s) may be the first symbol immediately after the last time domain symbol of the signaling carrying the idleness information, and the same is true for the above-mentioned Y slot(s).

It is understandable that the idleness window may be an independent time domain concept or a time-frequency domain concept. When the idleness window is a time-frequency domain concept, the idleness window may occupy one or more RBs, or a carrier, or a band, or a BWP, etc. in the frequency domain, which is not limited in the present disclosure.

Furthermore, the signaling carrying the idleness information when the idleness information is determined by the terminal is different from the signaling carrying the idleness information when the idleness information is determined by the base station. Therefore, the above-mentioned time point when sending of the signaling ends, the last time domain symbol for sending the signaling, and the slot where the last time domain symbol for sending the signaling is located may be specifically determined based on the device sending the idleness information.

In the embodiments of the present disclosure, the terminal receives the first signaling sent by the base station to obtain at least one uplink grant-free transmission resource on a bandwidth part configured by the base station for the terminal, and further determines, based on the idleness information, idle occasion(s) released from the transmission occasion of at least one uplink grant-free transmission resource, and then releases the idle occasion(s), so that the base station can reuse the idle occasion(s). Accordingly, the unused transmission occasion(s) can be reliably and effectively reused.

FIG. 3 is a flowchart of a method for determining an idle occasion according to an example embodiment. The method is performed by a terminal. As shown in FIG. 3, the method includes:

In S301, first signaling sent by a base station is received. The first signaling is used to indicate at least one uplink grant-free transmission resource on a bandwidth part configured by the base station for a terminal.

In S302, idleness information is sent to the base station.

In S303, according to the idleness information, an idle occasion released from a transmission occasion of the at least one uplink grant-free transmission resource is determined. The idle occasion is for reuse by the base station.

The idle occasion is an idle CG PUSCH occasion. The idleness information may be used to indicate an idle occasion in an uplink grant-free transmission resource that can be released by the terminal, and/or a non-idle occasion used by the terminal for an uplink transmission.

The first signaling may be single signaling, or may be a collective name for a plurality of pieces of signaling. For example, the first signaling may be single Radio Resource Control (RRC) signaling, or the first signaling may be formed by one piece of RRC signaling and one or more pieces of dynamic signaling. The dynamic signaling may, for example, carry Downlink Control Information (DCI).

One piece of idleness information may correspond to one uplink grant-free transmission resource. That is, one piece of idleness information may be used to indicate an idle occasion in one uplink grant-free transmission resource. If the base station configures a plurality of uplink grant-free transmission resources for the terminal in a bandwidth part, the idle occasion in each uplink grant-free transmission resource may be determined based on a plurality of pieces of idleness information. Alternatively, one piece of idleness information may correspond to a plurality of uplink grant-free transmission resources. That is, one piece of idleness information may be used to indicate idle occasion(s) in a plurality of uplink grant-free transmission resources.

In an example, the idleness information includes an occasion indication field, and the occasion indication field is used to indicate the number M of idle occasion(s) in transmission occasion(s).

Optionally, in this example:
the occasion indication field is used to indicate that M transmission occasion(s) after signaling carrying the idleness information is sent is (are) idle occasion(s); or
the occasion indication field is used to indicate that the first M transmission occasion(s) in an idleness window is (are) idle occasion(s); or
the occasion indication field is used to indicate that the last M transmission occasion(s) in the idleness window is (are) idle occasion(s); or
the occasion indication field is used to indicate that M transmission occasion(s) after a preset time length after the signaling carrying the idleness information is sent is (are) idle occasion(s);
the idleness window corresponds to a time domain resource and/or a frequency domain resource, and the candidate preset time length corresponds to a time domain resource.

It is understandable that the signaling carrying the idleness information when the idleness information is determined by the terminal is different from the signaling carrying the idleness information when the idleness information is determined by the base station. In addition, the idleness window may be used to indicate a time range, and the idleness window may be described by the number of symbols, the number of slots, or a time length. The preset time length may be an absolute time length.

The idleness window may be an independent time domain concept or a time-frequency domain concept. When the idleness window is the time-frequency domain concept, the idleness window may occupy one or more RBs, or a carrier, or a band, or a BWP, etc. in the frequency domain, which is not limited in the present disclosure.

In another example, the idleness information includes the idleness window and the occasion indication field. The occasion indication field includes N bits, and each bit is used to indicate whether a corresponding transmission occasion in the idleness window is idle.

The idleness information may specifically include information about the number of idleness window(s), time information of the idleness windows, such as the number of symbols or the number of slots, and/or information about the number of transmission occasion(s) in the idleness window(s), etc. The idleness information may include one or more idleness windows.

In an example, an idleness window includes N idleness sub-windows, and each bit of the N bits is further used to indicate whether a transmission occasion in an idleness sub-window is idle.

For example, if the length of the idleness window is W (W may be the number of symbols or the number of slots), the idleness window may be divided into N idleness sub-window(s). Specifically, the granularity of the first ┌W/N┐*N−W idleness sub-windows is └W/N┘, and the granularity of the last N+W−┌W/N┐*N idleness sub-windows is ┌W/N┐. Alternatively, the granularity of the first W−└W/N┘*N idleness sub-windows is ┌W/N┐, and the granularity of the last N−W+┌W/N┐*N idleness sub-windows is └W/N┘.

In another example, the transmission occasion(s) in the idleness window includes (include) N transmission occasion group(s), and each of the N bits is further used to indicate whether a transmission occasion group is idle. For example, if the idleness window includes W transmission occasions, the plurality of transmission occasions in the idleness window are divided into N transmission occasion groups. Specifically, the granularity of the first ┌W/N┐*N−W transmission occasion groups is └W/N┘, and the granularity of the last N+W−┌W/N┐*N transmission occasion groups is ┌W/N┐. Alternatively, the granularity of the first W−└W/N┘*N transmission occasion groups is ┌W/N┐, and the granularity of the last N−W+┌W/N┐*N transmission occasion groups is └W/N┘.

In yet another example, the idleness information includes an occasion indication granularity and an occasion indication field;
the occasion indication granularity is used to indicate a time period, where the time period is indicated by the number of symbols, or by the number of slots, or by a time length;
the occasion indication field includes N bits, and each bit is used to indicate whether transmission occasion(s) within an occasion indication granularity is (are) idle.

The starting time of the time period indicated by the first bit of the occasion indication field may be a time point when sending of the signaling carrying the idleness information ends, or the first symbol after the last time domain symbol of the signaling carrying the idleness information, or the first slot after a slot where the last time domain symbol of the signaling carrying the idleness information is located.

In yet another example, the idleness information includes the idleness window, and the idleness window is used to indicate that all transmission occasions within the idleness window are idle occasions.

In another example, the idleness information includes the occasion indication field, the occasion indication field includes N bits, and each bit is used to indicate whether a transmission occasion in an uplink grant-free transmission resource corresponding to the bit in the at least one uplink grant-free transmission resource is idle.

In an example, the idleness window does not include at least one of the following:
a downlink resource used for downlink data transmission; a flexible resource that is not configured with an uplink or downlink data transmission attribute; a resource occupied for transmitting a Synchronization Signal and Physical Broadcast Channel; a resource occupied by data transmitted through a physical downlink shared channel; a resource occupied for transmitting channel state information; a resource occupied for transmitting a sounding reference signal; a resource occupied by data transmitted through a physical downlink control channel.

In an example, the idleness window is any one of the following:
a preset time length after a time point when sending of the signaling carrying the idleness information ends; a time domain resource corresponding to X consecutive time domain symbol(s) after the last time domain symbol of the signaling carrying the idleness information; a time domain resource corresponding to Y consecutive slot(s) after a slot where the last time domain symbol of the signaling carrying idleness information is located; a frequency domain resource corresponding to the preset time length after the time point when sending of the signaling carrying the idleness information ends; a frequency domain resource corresponding to the X consecutive time domain symbol(s) after the last time domain symbol of the signaling carrying the idleness information; a frequency domain resource corresponding to the Y consecutive slot(s) after the slot where the last time domain symbol of the signaling carrying the idleness information is located. In the embodiment of the present disclosure, the terminal receives the first signaling sent by the base station to obtain the at least one uplink grant-free transmission resource configured by the base station for the terminal on a bandwidth part, and the terminal determines the idleness information corresponding to the uplink grant-free transmission resource and notifies the base station of the idleness information, and further releases the idle occasion(s) based on the idleness information determined by the terminal, so that the base station can reuse the idle occasion(s). Accordingly, the unused uplink grant-free transmission occasion(s) can be reliably and effectively reused.

FIG. 4 is a flowchart of a method for determining an idle occasion according to an example embodiment. The method is performed by a terminal. As shown in FIG. 4, the method includes:

In S401, first signaling sent by a base station is received. The first signaling is used to indicate at least one uplink grant-free transmission resource on a bandwidth part configured by the base station for a terminal.

In S402, Uplink Control Information (UCI) or RRC signaling is sent to the base station, where the uplink control information or the RRC signaling includes idleness information; or, alternatively, the idleness information is sent through a physical uplink shared channel.

In S403, according to the idleness information, an idle occasion released from a transmission occasion of the at least one uplink grant-free transmission resource is determined. The idle occasion is for reuse by the base station.

The idle occasion is an idle CG PUSCH occasion. The idleness information may be used to indicate an idle occasion in the uplink grant-free transmission resource that can be released by the terminal, and/or a non-idle occasion used by the terminal for uplink transmission.

In an example, the uplink control information or the RRC signaling is multiplexed on a physical uplink shared channel.

That is, the uplink control information or the RRC signaling is carried by the physical uplink shared channel, so as to send the idleness information in the uplink control information or the RRC signaling to the base station.

The first signaling may be single signaling or a collective name for a plurality of pieces of signaling. For example, the first signaling may be single Radio Resource Control (RRC) signaling, or the first signaling may be formed by one pieces of RRC signaling and one or more pieces of dynamic signaling. The dynamic signaling may, for example, carry Downlink Control Information (DCI).

One piece of idleness information may correspond to one uplink grant-free transmission resource. That is, one piece of idleness information may be used to indicate an idle occasion in one uplink grant-free transmission resource. If the base station configures a plurality of uplink grant-free transmission resources for the terminal in a bandwidth part, the idle occasion in each uplink grant-free transmission resource may be determined based on a plurality of pieces of idleness information. Alternatively, one piece of idleness information may correspond to a plurality of uplink grant-free transmission resources. That is, one piece of idleness information may be used to indicate idle occasion(s) in a plurality of uplink grant-free transmission resources.

In an example, the idleness information includes an occasion indication field, and the occasion indication field is used to indicate the number M of idle occasion(s) in transmission occasion(s).

Optionally, in this example:
the occasion indication field is used to indicate that M transmission occasion(s) after the signaling carrying the idleness information is sent is (are) idle occasion(s); or
the occasion indication field is used to indicate that the first M transmission occasion(s) in the idleness window is (are) idle occasion(s); or
the occasion indication field is used to indicate that the last M transmission occasion(s) in the idleness window is (are) idle occasion(s); or
the occasion indication field is used to indicate that the M transmission occasion(s) after a preset time length after the signaling carrying the idleness information is sent is (are) idle occasion(s);
the idleness window corresponds to a time domain resource and/or a frequency domain resource, and the candidate preset time length corresponds to a time domain resource.

It is understandable that the signaling carrying the idleness information when the idleness information is determined by the terminal is different from the signaling carrying the idleness information when the idleness information is determined by the base station. In addition, the idleness window may be used to indicate a time range, and the idleness window may be described by the number of symbols, the number of slots, or a time length. The preset time length may be an absolute time length.

The idleness window may be an independent time domain concept or a time-frequency domain concept. When the idleness window is the time-frequency domain concept, the idleness window may occupy one or more RBs, or a carrier, or a band, or a BWP, etc. in the frequency domain, which is not limited in the present disclosure.

In another example, the idleness information includes the idleness window and the occasion indication field. The occasion indication field includes N bits, and each bit is used to indicate whether a corresponding transmission occasion in the idleness window is idle.

The idleness information may specifically include information about the number of idleness window(s), time information of the idleness window(s), such as the number of symbols or the number of slots, and/or information about the number of transmission occasion(s) in the idleness window(s), etc. The idleness information may include one or more idleness windows.

In an example, an idleness window includes N idleness sub-windows, and each bit of the N bits is further used to indicate whether a transmission occasion in an idleness sub-window is idle.

For example, if the length of the idleness window is W (W may be the number of symbols or the number of slots), the idleness window may be divided into N idleness sub-window(s). Specifically, the granularity of the first ┌W/N┐*N−W idleness sub-windows is └W/N┘, and the granularity of the last N+W−┌W/N┐*N idleness sub-windows is ┌W/N┐. Alternatively, the granularity of the first W−└W/N┘*N idleness sub-windows is ┌W/N┐, and the granularity of the last N−W+┌W/N┐*N idleness sub-windows is └W/N┘.

In another example, the transmission occasion(s) in the idleness window includes (include) N transmission occasion group(s), and each bit of the N bits is further used to indicate whether a transmission occasion group is idle.

For example, if the idleness window includes W transmission occasions, the plurality of transmission occasions in the idleness window are divided into N transmission occasion groups. Specifically, the granularity of the first ┌W/N┐*N−W transmission occasion groups is └W/N┘, and the granularity of the lastN+W−┌W/N┐*N transmission occasion groups is ┌W/N┐. Alternatively, the granularity of the first W−└W/N┘*N transmission occasion groups is ┌W/N┐, and the granularity of the last N−W+┌W/N┐*N transmission occasion groups is └W/N┘

In yet another example, the idleness information includes an occasion indication granularity and the occasion indication field;
the occasion indication granularity is used to indicate a time period, where the time period is indicated by the number of symbols, or by the number of slots, or by a time length;
the occasion indication field includes N bits, and each bit is used to indicate whether transmission occasion(s) within an occasion indication granularity is (are) idle.

The starting time of the time period indicated by the first bit of the occasion indication field may be a time point when sending of the signaling carrying the idleness information ends, or the first symbol after the last time domain symbol of the signaling carrying the idleness information, or the first slot after a slot where the last time domain symbol of the signaling carrying the idleness information is located.

In yet another example, the idleness information includes the idleness window, and the idleness window is used to indicate that all transmission occasions within the idleness window are idle occasions.

In another example, the idleness information includes the occasion indication field, the occasion indication field includes N bits, and each bit is used to indicate whether a transmission occasion in an uplink grant-free transmission resource corresponding to the bit in the at least one uplink grant-free transmission resource is idle.

In an example, the idleness window does not include at least one of the following:
a downlink resource used for downlink data transmission; a flexible resource that is not configured with an uplink or downlink data transmission attribute; a resource occupied for transmitting a synchronization signal and physical broadcast channel; a resource occupied by data transmitted through a physical downlink shared channel; a resource occupied for transmitting channel state information; a resource occupied for transmitting a sounding reference signal; a resource occupied by data transmitted through a physical downlink control channel.

In an example, the idleness window is any one of the following:
a preset time length after a time point when sending of the signaling carrying the idleness information ends; a time domain resource corresponding to X consecutive time domain symbol(s) after the last time domain symbol of the signaling carrying the idleness information; a time domain resource corresponding to Y consecutive slot(s) after a slot where the last time domain symbol of the signaling carrying idleness information is located; a frequency domain resource corresponding to the preset time length after the time point when sending of the signaling carrying the idleness information ends; a frequency domain resource corresponding to the X consecutive time domain symbol(s) after the last time domain symbol of the signaling carrying the idleness information; a frequency domain resource corresponding to the Y consecutive slot(s) after the slot where the last time domain symbol of the signaling carrying the idleness information is located. In the embodiment of the present disclosure, the terminal receives the first signaling sent by the base station to obtain at least one uplink grant-free transmission resource configured by the base station for the terminal on a bandwidth part, and the terminal determines the idleness information corresponding to the uplink grant-free transmission resource and notifies the base station, and further releases the idle occasion(s) based on the idleness information determined by the terminal, so that the base station can reuse the idle occasion(s). Accordingly, the unused uplink grant-free transmission occasion(s) can be reliably and effectively reused.

FIG. 5 is a flowchart of a method for determining an idle occasion according to an example embodiment. The method is performed by a terminal. As shown in FIG. 5, the method includes:

In S501, first signaling sent by a base station is received. The first signaling is used to indicate at least one uplink grant-free transmission resource on a bandwidth part configured by the base station for the terminal.

In S502, idleness information sent by the base station is received through RRC signaling or downlink control information.

In S503, according to the idleness information, an idle occasion released from a transmission occasion of the at least one uplink grant-free transmission resource is determined. The idle occasion is for reuse by the base station.

The idle occasion is an idle CG PUSCH occasion. The idleness information may be used to indicate an idle occasion in an uplink grant-free transmission resource that can be released by the terminal, and/or a non-idle occasion used by the terminal for uplink transmission.

The first signaling may be single signaling or a collective name for a plurality of pieces of signaling. For example, the first signaling may be single Radio Resource Control (RRC) signaling, or may be formed by one piece of RRC signaling and one or more pieces of dynamic signaling. The dynamic signaling may carry Downlink Control Information (DCI) for example. In a possible implementation, the idleness information may be carried by the first signaling to save signaling. For example, the base station may carry downlink control information through dynamic signaling, and the downlink control information may carry the idleness information determined by the base station. Alternatively, the RRC signaling or downlink control information carrying the idleness information is separate single signaling, which is not limited in the present disclosure.

In an example, if the idleness information determined by the base station is used to indicate an idle occasion released from an uplink grant-free transmission resource, the idleness information may be carried through dynamic signaling. That is, the dynamic signaling may not only carry a part of configuration information of the uplink grant-free transmission resource to be used to activate the uplink grant-free transmission resource, but also indicate the idleness information determined by the base station. In this way, the terminal can autonomously perform uplink transmission at a non-idle occasion configured in the uplink grant-free transmission resource within a period configured by the base station.

One piece of idleness information may correspond to one uplink grant-free transmission resource. That is, one piece of idleness information may be used to indicate an idle occasion in one uplink grant-free transmission resource. If the base station configures a plurality of uplink grant-free transmission resources for the terminal in a bandwidth part, the idle occasion in each uplink grant-free transmission resource may be determined based on a plurality of pieces of idleness information. Alternatively, one piece of idleness information may correspond to a plurality of uplink grant-free transmission resources. That is, one piece of idleness information may be used to indicate idle occasion(s) in a plurality of uplink grant-free transmission resources.

In an example, the idleness information includes an occasion indication field, and the occasion indication field is used to indicate the number M of idle occasion(s) in uplink grant-free transmission occasion(s).

Optionally, in this example:
the occasion indication field is used to indicate that M transmission occasion(s) after the signaling carrying the idleness information is sent is (are) idle occasion(s); or
the occasion indication field is used to indicate that the first M transmission occasion(s) in the idleness window is (are) idle occasion(s); or
the occasion indication field is used to indicate that the last M transmission occasion(s) in the idleness window is (are) idle occasion(s); or
the occasion indication field is used to indicate that M transmission occasion(s) after a preset time length after the signaling carrying the idleness information is sent is (are) idle occasion(s);
the idleness window corresponds to a time domain resource and/or a frequency domain resource, and the candidate preset time length corresponds to a time domain resource.

It is understandable that the signaling carrying the idleness information when the idleness information is determined by the terminal is different from the signaling carrying the idleness information when the idleness information is determined by the base station. In addition, the idleness window may be used to indicate a time range, and the idleness window may be described by the number of symbols, the number of slots, or a time length. The preset time length may be an absolute time length.

The idleness window may be an independent time domain concept or a time-frequency domain concept. When the idleness window is a time-frequency domain concept, the idleness window may occupy one or more RBs, or a carrier, or a band, or a BWP, etc. in the frequency domain, which is not limited in the present disclosure.

In another example, the idleness information includes an idleness window and an occasion indication field, the occasion indication field includes N bits, and each bit is used to indicate whether a corresponding transmission occasion in the idleness window is idle.

The idleness information may specifically include information about the number of idleness window(s), time information of the idleness window(s), such as the number of symbols or the number of slots, and/or information about the number of transmission occasion(s) in the idleness window(s), etc. The idleness information may include one or more idleness windows.

In an example, an idleness window includes N idleness sub-windows, and each bit of the N bits is further used to indicate whether a transmission occasion in an idleness sub-window is idle. For example, if the length of the idleness window is W (W may be the number of symbols or the number of slots), the idleness window may be divided into N idleness sub-window(s). Specifically, the granularity of the first ┌W/N┐*N−W idleness sub-windows is └W/N┘, and the granularity of the last N+W−┌W/N┐*N idleness sub-windows is ┌W/N┐. Alternatively, the granularity of the first W−└W/N┘*N idleness sub-windows is ┌W/N┐, and the granularity of the last N−W+┌W/N┐*N idleness sub-windows is └W/N┘.

In another example, the transmission occasion(s) in the idleness window includes (include) N transmission occasion group(s), and each bit of the N bits is further used to indicate whether a transmission occasion group is idle.

For example, if the idleness window includes W transmission occasions, the plurality of transmission occasions in the idleness window are divided into N transmission occasion groups. Specifically, the granularity of the first ┌W/N┐*N−W transmission occasion groups is └W/N┘, and the granularity of the last N+W−┌W/N┐*N transmission occasion groups is ┌W/N┐. Alternatively, the granularity of the first W−└W/N┘*N transmission occasion groups is ┌W/N┐, and the granularity of the last N−W+┌W/N┐*N transmission occasion groups is └W/N┘.

In yet another example, the idleness information includes an occasion indication granularity and the occasion indication field;
the occasion indication granularity is used to indicate a time period, where the time period is indicated by the number of symbols, or by the number of slots, or by a time length;
the occasion indication field includes N bits, and each bit is used to indicate whether transmission occasion(s) within an occasion indication granularity is (are) idle.

The starting time of the time period indicated by the first bit of the occasion indication field may be a time point when sending of the signaling carrying the idleness information ends, or the first symbol after the last time domain symbol of the signaling carrying the idleness information, or the first slot after a slot where the last time domain symbol of the signaling carrying the idleness information is located.

In yet another example, the idleness information includes an idleness window, and the idleness window is used to indicate that all transmission occasions within the idleness window are idle occasions.

In another example, the idleness information includes the occasion indication field, the occasion indication field includes N bits, and each bit is used to indicate whether a transmission occasion in an uplink grant-free transmission resource corresponding to the bit in the at least one uplink grant-free transmission resource is idle.

In an example, the idleness window does not include at least one of the following:
a downlink resource used for downlink data transmission; a flexible resource that is not configured with an uplink or downlink data transmission attribute; a resource occupied for transmitting a synchronization signal and physical broadcast channel; a resource occupied by data transmitted through a physical downlink shared channel; a resource occupied for transmitting channel state information; a resource occupied for transmitting a sounding reference signal; a resource occupied by data transmitted through a physical downlink control channel.

In an example, the idleness window is any one of the following:
a preset time length after a time point when sending of the signaling carrying the idleness information ends; a time domain resource corresponding to X consecutive time domain symbol(s) after the last time domain symbol of the signaling carrying the idleness information; a time domain resource corresponding to Y consecutive slot(s) after a slot where the last time domain symbol of the signaling carrying idleness information is located; a frequency domain resource corresponding to the preset time length after the time point when sending of the signaling carrying the idleness information ends; a frequency domain resource corresponding to the X consecutive time domain symbol(s) after the last time domain symbol of the signaling carrying the idleness information; a frequency domain resource corresponding to the Y consecutive slot(s) after the slot where the last time domain symbol of the signaling carrying the idleness information is located. In the embodiments of the present disclosure, the terminal receives the first signaling sent by the base station to obtain at least one uplink grant-free transmission resource configured by the base station for the terminal on a bandwidth part, and the base station indicates the idleness information corresponding to the uplink grant-free transmission resource, and further releases the idle occasion(s) based on the idleness information determined by the base station, so that the base station can reuse the idle occasion(s). Accordingly, the unused uplink grant-free transmission occasion(s) can be reliably and effectively reused.

FIG. 6 is a flowchart of a method for determining an idle occasion according to an example embodiment. The method is performed by a terminal. As shown in FIG. 6, the method includes:

In S601, RRC signaling sent by a base station is received. The RRC signaling is used to indicate, to the terminal, all configuration information of the uplink grant-free transmission resource(s).

In S602, according to idleness information, an idle occasion released from a transmission occasion of at least one uplink grant-free transmission resource is determined. The idle occasion is for reuse by the base station.

The idle occasion is an idle CG PUSCH occasion. The idleness information may be used to indicate an idle occasion in an uplink grant-free transmission resource that can be released by the terminal, and/or a non-idle occasion used by the terminal for uplink transmission.

In a possible implementation, the idleness information may be carried by the RRC signaling to save signaling. Alternatively, the RRC signaling or downlink control information carrying the idleness information is separate single signaling, which is not limited in the present disclosure.

One piece of idleness information may correspond to one uplink grant-free transmission resource. That is, one piece of idleness information may be used to indicate an idle occasion in one uplink grant-free transmission resource. If the base station configures a plurality of uplink grant-free transmission resources for the terminal in a bandwidth part, the idle occasion in each uplink grant-free transmission resource may be determined based on a plurality of pieces of idleness information.

In an example, the idleness information includes an occasion indication field, and the occasion indication field is used to indicate the number M of idle occasion(s) in uplink grant-free transmission occasion(s).

Optionally, in this example:
the occasion indication field is used to indicate that M transmission occasion(s) after the signaling carrying the idleness information is sent is (are) idle occasion(s); or
the occasion indication field is used to indicate that the first M transmission occasion(s) in the idleness window is (are) idle occasion(s); or
the occasion indication field is used to indicate that the last M transmission occasion(s) in the idleness window is (are) idle occasion(s); or
the occasion indication field is used to indicate that M transmission occasion(s) after a preset time length after the signaling carrying the idleness information is sent is (are) idle occasion(s);
the idleness window corresponds to a time domain resource and/or a frequency domain resource, and the candidate preset time length corresponds to a time domain resource.

It is understandable that that the signaling carrying the idleness information when the idleness information is determined by the terminal is different from the signaling carrying the idleness information when the idleness information is determined by the base station. In addition, the idleness window may be used to indicate a time range, and the idleness window may be described by the number of symbols, the number of slots, or a time length. The preset time length may be an absolute time length.

The idleness window may be an independent time domain concept or a time-frequency domain concept. When the idleness window is a time-frequency domain concept, the idleness window may occupy one or more RBs, or a carrier, or a band, or a BWP, etc. in the frequency domain, which is not limited in the present disclosure.

In another example, the idleness information includes an idleness window and an occasion indication field, the occasion indication field includes N bits, and each bit is used to indicate whether a corresponding transmission occasion in the idleness window is idle.

The idleness information may specifically include information about the number of idleness window(s), time information of the idleness window(s), such as the number of symbols or the number of slots, and/or information about the number of transmission occasion(s) in the idleness window(s), etc. The idleness information may include one or more idleness windows.

In an example, the idleness window includes N idleness sub-windows, and each of the N bits is further used to indicate whether a transmission occasion in an idleness sub-window is idle.

For example, if the length of the idleness window is W (W may be the number of symbols or the number of slots), the idleness window may be divided into N idleness sub-window(s). Specifically, the granularity of the first ┌W/N┐*N−W idleness sub-windows is └W/N┘, and the granularity of the last N+W−┌W/N┐*N idleness sub-windows is ┌W/N┐. Alternatively, the granularity of the first W−└W/N┘*N idleness sub-windows is ┌W/N┐, and the granularity of the last N−W+┌W/N┐*N idleness sub-windows is └W/N┘.

In another example, the transmission occasion(s) in the idleness window includes (include) N transmission occasion group(s), and each bit of the N bits is further used to indicate whether a transmission occasion group is idle.

For example, if the idleness window includes W transmission occasions, the plurality of transmission occasions in the idleness window are divided into N transmission occasion groups. Specifically, the granularity of the first ┌W/N┐*N−W transmission occasion groups is └W/N┘, and the granularity of the last N+W−┌W/N┐*N transmission occasion groups is ┌W/N┐. Alternatively, the granularity of the first W−└W/N┘*N transmission occasion groups is ┌W/N┐, and the granularity of the last N−W+┌W/N┐*N transmission occasion groups is └W/N┘.

In yet another example, the idleness information includes an occasion indication granularity and the occasion indication field;
the occasion indication granularity is used to indicate a time period, where the time period is indicated by the number of symbols, or by the number of slots, or by a time length;
the occasion indication field includes N bits, and each bit is used to indicate whether transmission occasion(s) within an occasion indication granularity is (are) idle.

The starting time of the time period indicated by the first bit of the occasion indication field may be a time point when sending of the signaling carrying the idleness information ends, or the first symbol after the last time domain symbol of the signaling carrying the idleness information, or the first slot after a slot where the last time domain symbol of the signaling carrying the idleness information is located.

In yet another example, the idleness information includes an idleness window, and the idleness window is used to indicate that all transmission occasions within the idleness window are idle occasions.

In another example, the idleness information includes an occasion indication field, the occasion indication field includes N bits, and each bit is used to indicate whether a transmission occasion in an uplink grant-free transmission resource corresponding to the bit in the at least one uplink grant-free transmission resource is idle.

In an example, the idleness window does not include at least one of the following:
a downlink resource used for downlink data transmission; a flexible resource that is not configured with an uplink or downlink data transmission attribute; a resource occupied for transmitting a synchronization signal and physical broadcast channel; a resource occupied by data transmitted through a physical downlink shared channel; a resource occupied for transmitting channel state information; a resource occupied for transmitting a sounding reference signal; a resource occupied by data transmitted through a physical downlink control channel.

In an example, the idleness window is any one of the following:
a preset time length after a time point when sending of the signaling carrying the idleness information ends; a time domain resource corresponding to X consecutive time domain symbol(s) after the last time domain symbol of the signaling carrying the idleness information; a time domain resource corresponding to Y consecutive slot(s) after a slot where the last time domain symbol of the signaling carrying idleness information is located; a frequency domain resource corresponding to the preset time length after the time point when sending of the signaling carrying the idleness information ends; a frequency domain resource corresponding to the X consecutive time domain symbol(s) after the last time domain symbol of the signaling carrying the idleness information; a frequency domain resource corresponding to the Y consecutive slot(s) after the slot where the last time domain symbol of the signaling carrying the idleness information is located. In the embodiments of the present disclosure, the terminal receives the first signaling sent by the base station to obtain at least one uplink grant-free transmission resource configured by the base station for the terminal on a bandwidth part, and further releases the idle occasion(s) based on the idleness information determined by the terminal, so that the base station can reuse the idle occasion(s). Accordingly, the unused uplink grant-free transmission occasion(s) can be reliably and effectively reused.

FIG. 7 is a flowchart of a method for determining an idle occasion according to an example embodiment. The method is performed by a terminal. As shown in FIG. 7, the method includes:

In S701, RRC signaling sent by a base station is received. The RRC signaling is used to indicate, to the terminal, a part of configuration information of uplink grant-free transmission resource(s).

In S702, dynamic signaling sent by the base station is received. The dynamic signaling is used to indicate, to the terminal, remaining configuration information of uplink grant-free transmission resource(s) and to indicate the terminal to activate uplink grant-free transmission resource(s).

In S703, according to idleness information, an idle occasion released from a transmission occasion of at least one uplink grant-free transmission resource is determined. The idle occasion is for reuse by the base station.

There may be one or more uplink grant-free transmission resources, and the granularity of the idleness information may be in one-to-one correspondence of the uplink grant-free transmission resources. That is, one piece of idleness information is used to indicate an idle occasion in one uplink grant-free transmission resource. Alternatively, one piece of idleness information may be used to indicate the idle occasion(s) released in all uplink grant-free transmission resources.

An idle occasion is an idle CG PUSCH occasion. The idleness information may be used to indicate an idle occasion in an uplink grant-free transmission resource that can be released by the terminal, and/or a non-idle occasion used by the terminal for uplink transmission.

In an example, the dynamic signaling may carry the idleness information determined by the base station.

It can be understood that the RRC signaling may include a part of configuration information of one or more uplink grant-free transmission resources, and the remaining configuration information of the uplink grant-free transmission resources in the dynamic signaling may only include the remaining configuration information of a part of the uplink grant-free transmission resources.

For example, if the RRC signaling includes a part of configuration information of 8 uplink grant-free transmission resources, the dynamic signaling may only include the remaining configuration information of one uplink grant-free transmission resource, that is, the dynamic signaling is only used to activate the uplink grant-free transmission resource. Furthermore, the terminal may only determine the idle occasion to be released in the uplink grant-free transmission resource.

One piece of idleness information may correspond to one uplink grant-free transmission resource. That is, one piece of idleness information may be used to indicate an idle occasion in one uplink grant-free transmission resource. If the base station configures a plurality of uplink grant-free transmission resources for the terminal in a bandwidth part, the idle occasion in each uplink grant-free transmission resource may be determined based on a plurality of pieces of idleness information.

In a possible implementation, the idleness information may be carried through the RRC signaling or the dynamic signaling to save signaling. For example, the idleness information may be determined by the base station, and the downlink control information may be carried by the dynamic signaling, and the downlink control information may be used to carry the idleness information determined by the base station and sent to the terminal. Alternatively, the RRC signaling or the downlink control information carrying the idleness information is separate signaling, which is not limited in the present disclosure. In an example, the idleness information includes an occasion indication field, which is used to indicate the number M of idle occasion(s) in the uplink grant-free transmission occasion(s).

Optionally, in this example:
the occasion indication field is used to indicate that M transmission occasion(s) after the signaling carrying the idleness information is sent is (are) idle occasion(s); or
the occasion indication field is used to indicate that the first M transmission occasion(s) in the idleness window is (are) idle occasion(s); or
the occasion indication field is used to indicate that the last M transmission occasion(s) in the idleness window is (are) idle occasion(s); or
the occasion indication field is used to indicate that M transmission occasion(s) after a preset time length after the signaling carrying the idleness information is sent is (are) idle occasion(s);
the idleness window corresponds to a time domain resource and/or a frequency domain resource, and the candidate preset time length corresponds to a time domain resource.

It is understandable that that the signaling carrying the idleness information when the idleness information is determined by the terminal is different from the signaling carrying the idleness information when the idleness information is determined by the base station. In addition, the idleness window may be used to indicate a time range, and the idleness window may be described by the number of symbols, the number of slots, or a time length. The preset time length may be an absolute time length.

The idleness window may be an independent time domain concept or a time-frequency domain concept. When the idleness window is a time-frequency domain concept, the idleness window may occupy one or more RBs, or a carrier, or a band, or a BWP, etc. in the frequency domain, which is not limited in the present disclosure.

In another example, the idleness information includes an idleness window and an occasion indication field, the occasion indication field includes N bits, and each bit is used to indicate whether a corresponding transmission occasion in the idleness window is idle.

The idleness information may specifically include information about the number of idleness window(s), time information of the idleness window(s), such as the number of symbols or the number of slots, and/or information about the number of transmission occasion(s) in the idleness window(s), etc. The idleness information may include one or more idleness windows.

In an example, the idleness window includes N idleness sub-windows, and each of the N bits is further used to indicate whether a transmission occasion in an idleness sub-window is idle.

For example, if the length of the idleness window is W (W may be the number of symbols or the number of slots), the idleness window may be divided into N idleness sub-window(s). Specifically, the granularity of the first ┌W/N┐*N−W idleness sub-windows is └W/N┘, and the granularity of the last N+W−┌W/N┐*N idleness sub-windows is ┌W/N┐. Alternatively, the granularity of the first W−└W/N┘*N idleness sub-windows is ┌W/N┐, and the granularity of the last N−W+┌W/N┐*N idleness sub-windows is └W/N┘.

In another example, the transmission occasion(s) in the idleness window includes (include) N transmission occasion group(s), and each bit of the N bits is further used to indicate whether a transmission occasion group is idle.

For example, if the idleness window includes W transmission occasions, the plurality of transmission occasions in the idleness window are divided into N transmission occasion groups. Specifically, the granularity of the first ┌W/N┐*N−W transmission occasion groups is └W/N┘, and the granularity of the last N+W−┌W/N┐*N transmission occasion groups is ┌W/N┐. Alternatively, the granularity of the first W−└W/N┘*N transmission occasion groups is ┌W/N┐, and the granularity of the last N−W+┌W/N┐*N transmission occasion groups is └W/N┘.

In yet another example, the idleness information includes an occasion indication granularity and the occasion indication field;
the occasion indication granularity is used to indicate a time period, where the time period is indicated by the number of symbols, or by the number of slots, or by a time length;
the occasion indication field includes N bits, and each bit is used to indicate whether transmission occasion(s) within an occasion indication granularity is (are) idle.

The starting time of the time period indicated by the first bit of the occasion indication field may be a time point when sending of the signaling carrying the idleness information ends, or the first symbol after the last time domain symbol of the signaling carrying the idleness information, or the first slot after a slot where the last time domain symbol of the signaling carrying the idleness information is located.

In yet another example, the idleness information includes an idleness window, and the idleness window is used to indicate that all transmission occasions within the idleness window are idle occasions.

In another example, the idleness information includes an occasion indication field, the occasion indication field includes N bits, and each bit is used to indicate whether a transmission occasion in an uplink grant-free transmission resource corresponding to the bit in the at least one uplink grant-free transmission resource is idle.

In an example, the idleness window does not include at least one of the following:
a downlink resource used for downlink data transmission; a flexible resource that is not configured with an uplink or downlink data transmission attribute; a resource occupied for transmitting a synchronization signal and physical broadcast channel; a resource occupied by data transmitted through a physical downlink shared channel; a resource occupied for transmitting channel state information; a resource occupied for transmitting a sounding reference signal; a resource occupied by data transmitted through a physical downlink control channel.

In an example, the idleness window is any one of the following:
a preset time length after a time point when sending of the signaling carrying the idleness information ends; a time domain resource corresponding to X consecutive time domain symbol(s) after the last time domain symbol of the signaling carrying the idleness information; a time domain resource corresponding to Y consecutive slot(s) after a slot where the last time domain symbol of the signaling carrying idleness information is located; a frequency domain resource corresponding to the preset time length after the time point when sending of the signaling carrying the idleness information ends; a frequency domain resource corresponding to the X consecutive time domain symbol(s) after the last time domain symbol of the signaling carrying the idleness information; a frequency domain resource corresponding to the Y consecutive slot(s) after the slot where the last time domain symbol of the signaling carrying the idleness information is located. In the embodiments of the present disclosure, the terminal receives the RRC signaling and the dynamic signaling sent by the base station, and dynamic activation of uplink grant-free resource(s) can be realized, and the terminal can know at least one uplink grant-free transmission resource configured by the base station for the terminal on a bandwidth part, and further release the idle occasion(s) in the activated uplink grant-free resource(s) based on the idleness information, so that the base station can reuse the idle occasion(s). Accordingly, the unused uplink grant-free transmission occasion(s) can be reliably and effectively reused.

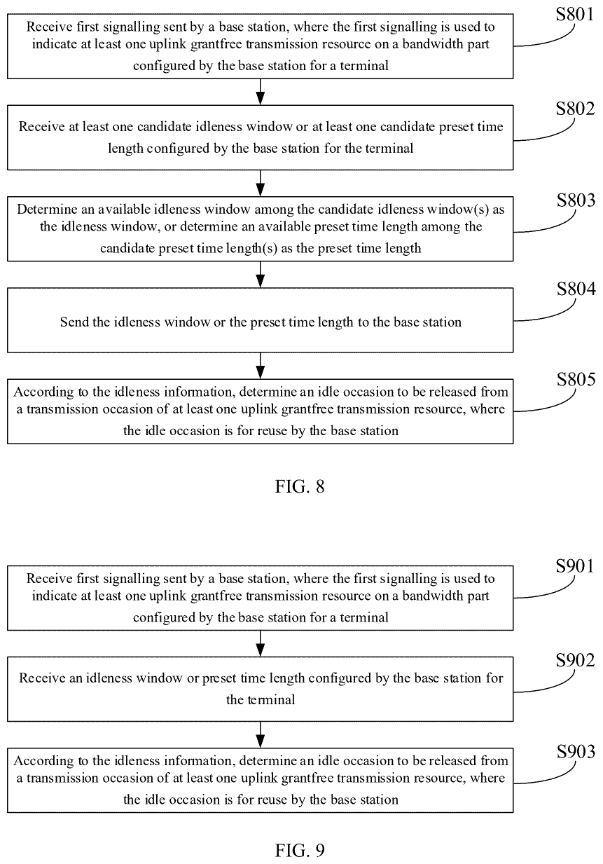

FIG. 8 is a flowchart of a method for determining an idle occasion according to an example embodiment. The method is performed by a terminal. As shown in FIG. 8, the method includes:

In S801, first signaling sent by a base station is received. The first signaling is used to indicate at least one uplink grant-free transmission resource on a bandwidth part configured by the base station for a terminal.

In S802, at least one candidate idleness window or at least one candidate preset time length configured by the base station for the terminal is received.

In S803, an available idleness window among the candidate idleness window(s) is determined as the idleness window, or an available preset time length among the candidate preset time length(s) is determined as the preset time length.

In S804, the idleness window or the preset time length is sent to the base station.

In S805, according to idleness information, an idle occasion released from a transmission occasion of at least one uplink grant-free transmission resource is determined. The idle occasion is for reuse by the base station.

The at least one candidate idleness window or the at least one candidate preset time length may be configured by the base station through higher layer signaling. That is, the terminal can send an idleness window or a preset time length to the base station, and the idleness window or the preset time length is determined from the at least one candidate idleness window or the at least one candidate preset time length based on step S803. The at least one candidate idleness window or the at least one candidate preset time length is configured by the base station for the terminal, and the terminal receives the at least one candidate idleness window or the at least one candidate preset time length through step S802.

In step S803, the terminal may determine an available idleness window or an available preset time length from the at least one candidate idleness window or the at least one candidate preset time length based on its own capability, such as a signal processing capability and a hardware capability, etc.

The idleness information includes an occasion indication field, and the occasion indication field is used to indicate the number M of idle occasion(s) in uplink grant-free transmission occasion(s).

The occasion indication field is used to indicate that M transmission occasion(s) after the signaling carrying the idleness information is sent is (are) idle occasion(s); or
the occasion indication field is used to indicate that the first M transmission occasion(s) in the idleness window is (are) idle occasion(s); or
the occasion indication field is used to indicate that the last M transmission occasion(s) in the idleness window is (are) idle occasion(s); or
the occasion indication field is used to indicate that M transmission occasion(s) after a preset time length after the signaling carrying the idleness information is sent is (are) idle occasion(s);
the idleness window corresponds to a time domain resource and/or a frequency domain resource, and the candidate preset time length corresponds to a time domain resource.

An idle occasion is an idle CG PUSCH occasion. The idleness information may be used to indicate an idle occasion in an uplink grant-free transmission resource that can be released by the terminal, and/or a non-idle occasion used by the terminal for uplink transmission.

The first signaling may be single signaling or a collective name for a plurality of pieces of signaling. For example, the first signaling may be single Radio Resource Control (RRC) signaling, or may be formed by one piece of RRC signaling and one or more pieces of dynamic signaling. The dynamic signaling may carry Downlink Control Information (DCI) for example. In a possible implementation, the idleness information may be carried by the first signaling to save signaling. For example, the base station may carry downlink control information through dynamic signaling, and the downlink control information may carry the idleness information determined by the base station. Alternatively, RRC signaling or downlink control information carrying the idleness information is separate signaling, which is not limited in the present disclosure.

In an example, the idleness window does not include at least one of the following:
a downlink resource used for downlink data transmission; a flexible resource that is not configured with an uplink or downlink data transmission attribute; a resource occupied for transmitting a synchronization signal and physical broadcast channel; a resource occupied by data transmitted through a physical downlink shared channel; a resource occupied for transmitting channel state information; a resource occupied for transmitting a sounding reference signal; a resource occupied by data transmitted through a physical downlink control channel.

In an example, the idleness window is any one of the following:
a preset time length after a time point when sending of the signaling carrying the idleness information ends; a time domain resource corresponding to X consecutive time domain symbol(s) after the last time domain symbol of the signaling carrying the idleness information; a time domain resource corresponding to Y consecutive slot(s) after a slot where the last time domain symbol of the signaling carrying idleness information is located; a frequency domain resource corresponding to the preset time length after the time point when sending of the signaling carrying the idleness information ends; a frequency domain resource corresponding to the X consecutive time domain symbol(s) after the last time domain symbol of the signaling carrying the idleness information; a frequency domain resource corresponding to the Y consecutive slot(s) after the slot where the last time domain symbol of the signaling carrying the idleness information is located. In the embodiments of the present disclosure, the terminal can know at least one uplink grant-free transmission resource configured by the base station for the terminal on a bandwidth part by receiving the first signaling sent by the base station. Further, the terminal can select an available idleness window or preset time length from the at least one candidate idleness window or the at least one candidate preset time length configured by the base station for the terminal. Further, the terminal can release the idle occasion(s) in the activated uplink grant-free resource(s) based on the idleness information, so that the base station can reuse the idle occasion(s). Accordingly, the unused uplink grant-free transmission occasion(s) can be reliably and effectively reused.

FIG. 9 is a flowchart of a method for determining an idle occasion according to an example embodiment. The method is performed by a terminal. As shown in FIG. 9, the method includes:

In S901, first signaling sent by a base station is received. The first signaling is used to indicate at least one uplink grant-free transmission resource on a bandwidth part configured by the base station for the terminal.

In S902, an idleness window or a preset time length configured by the base station for the terminal is received.

In S903, according to idleness information, an idle occasion released from a transmission occasion of at least one uplink grant-free transmission resource is determined. The idle occasion is for reuse by the base station.

The idleness window or the preset time length may be configured by the base station through higher layer signaling.

The idleness information includes an occasion indication field, and the occasion indication field is used to indicate the number M of idle occasion(s) in uplink grant-free transmission occasion(s).

The occasion indication field is used to indicate that M transmission occasion(s) after the signaling carrying the idleness information is sent is (are) idle occasion(s); or
the occasion indication field is used to indicate that the first M transmission occasion(s) in the idleness window is (are) idle occasion(s); or
the occasion indication field is used to indicate that the last M transmission occasion(s) in the idleness window is (are) idle occasion(s); or
the occasion indication field is used to indicate that M transmission occasion(s) after a preset time length after the signaling carrying the idleness information is sent is (are) idle occasion(s);
the idleness window corresponds to a time domain resource and/or a frequency domain resource, and the candidate preset time length corresponds to a time domain resource.

An idle occasion is an idle CG PUSCH occasion. The idleness information may be used to indicate an idle occasion in an uplink grant-free transmission resource that can be released by the terminal, and/or a non-idle occasion used by the terminal for uplink transmission.

The first signaling may be single signaling or a collective name for a plurality of pieces of signaling. For example, the first signaling may be single Radio Resource Control (RRC) signaling, or may be formed by one piece of RRC signaling and one or more pieces of dynamic signaling. The dynamic signaling may carry Downlink Control Information (DCI) for example. In a possible implementation, the idleness information may be carried by the first signaling to save signaling. For example, the base station may carry downlink control information through dynamic signaling, and the downlink control information may carry the idleness information determined by the base station. Alternatively, RRC signaling or downlink control information carrying the idleness information is separate signaling, which is not limited in the present disclosure.

In an example, the idleness window does not include at least one of the following:
a downlink resource used for downlink data transmission; a flexible resource that is not configured with an uplink or downlink data transmission attribute; a resource occupied for transmitting a synchronization signal and physical broadcast channel; a resource occupied by data transmitted through a physical downlink shared channel; a resource occupied for transmitting channel state information; a resource occupied for transmitting a sounding reference signal; a resource occupied by data transmitted through a physical downlink control channel.

In an example, the idleness window is any one of the following:
a preset time length after a time point when sending of the signaling carrying the idleness information ends; a time domain resource corresponding to X consecutive time domain symbol(s) after the last time domain symbol of the signaling carrying the idleness information; a time domain resource corresponding to Y consecutive slot(s) after a slot where the last time domain symbol of the signaling carrying idleness information is located; a frequency domain resource corresponding to the preset time length after the time point when sending of the signaling carrying the idleness information ends; a frequency domain resource corresponding to the X consecutive time domain symbol(s) after the last time domain symbol of the signaling carrying the idleness information; a frequency domain resource corresponding to the Y consecutive slot(s) after the slot where the last time domain symbol of the signaling carrying the idleness information is located. In the embodiments of the present disclosure, the terminal can know at least one uplink grant-free transmission resource configured by the base station for the terminal on a bandwidth part by receiving the first signaling sent by the base station. Further, the terminal can release the idle occasion(s) in the activated uplink grant-free resource(s) based on the idleness information according to the idleness window or the preset time length configured by the base station for the terminal, so that the base station can reuse the idle occasion(s). Accordingly, unused uplink grant-free transmission occasion(s) can be reliably and effectively reused.

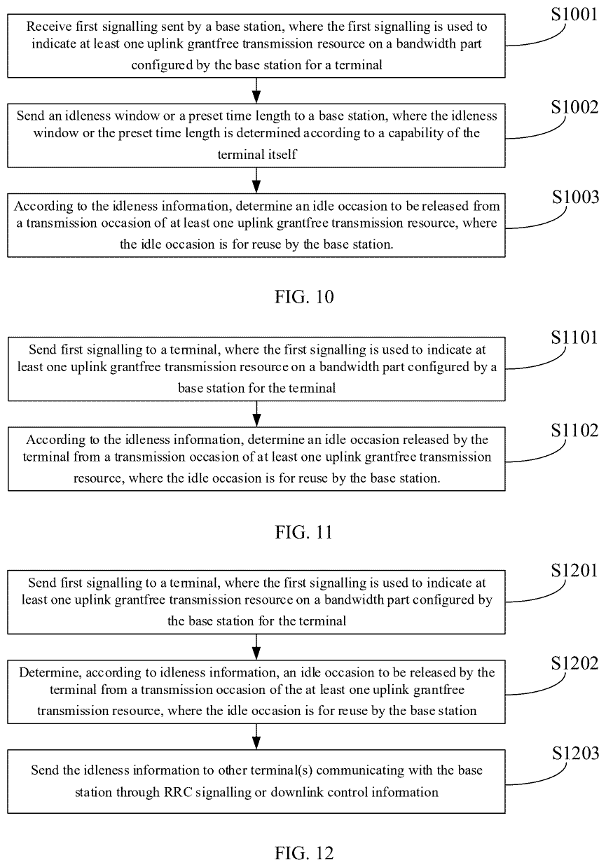

FIG. 10 is a flowchart of a method for determining an idle occasion according to an example embodiment. The method is performed by a terminal. As shown in FIG. 10, the method includes:

In S1001, first signaling sent by a base station is received. The first signaling is used to indicate at least one uplink grant-free transmission resource on a bandwidth part configured by the base station for the terminal.

In S1002, an idleness window or a preset time length is sent to the base station. The idleness window or the preset time length is determined according to a capability of the terminal.

In S1003, according to idleness information, an idle occasion released from a transmission occasion of at least one uplink grant-free transmission resource is determined. The idle occasion is for reuse by the base station.

In step S1002, the terminal may determine the idleness window or the preset time length by itself, for example, based on its own signal processing capability and hardware capability, etc.

The idleness information includes an occasion indication field, and the occasion indication field is used to indicate the number M of idle occasion(s) in uplink grant-free transmission occasion(s).

The occasion indication field is used to indicate that M transmission occasion(s) after the signaling carrying the idleness information is sent is (are) idle occasion(s); or
the occasion indication field is used to indicate that the first M transmission occasion(s) in the idleness window is (are) idle occasion(s); or
the occasion indication field is used to indicate that the last M transmission occasion(s) in the idleness window is (are) idle occasion(s); or
the occasion indication field is used to indicate that M transmission occasion(s) after a preset time length after the signaling carrying the idleness information is sent is (are) idle occasion(s);
the idleness window corresponds to a time domain resource and/or a frequency domain resource, and the candidate preset time length corresponds to a time domain resource.

An idle occasion is an idle CG PUSCH occasion. The idleness information may be used to indicate an idle occasion in an uplink grant-free transmission resource that can be released by the terminal, and/or a non-idle occasion used by the terminal for uplink transmission.

The first signaling may be single signaling or a collective name for a plurality of pieces of signaling. For example, the first signaling may be single Radio Resource Control (RRC) signaling, or may be formed by one piece of RRC signaling and one or more pieces of dynamic signaling. The dynamic signaling may carry Downlink Control Information (DCI) for example. In a possible implementation, the base station may carry downlink control information through dynamic signaling, and carry the idleness information determined by the base station through the downlink control information to save signaling.

In an example, the idleness window does not include at least one of the following:
a downlink resource used for downlink data transmission; a flexible resource that is not configured with an uplink or downlink data transmission attribute; a resource occupied for transmitting a synchronization signal and physical broadcast channel; a resource occupied by data transmitted through a physical downlink shared channel; a resource occupied for transmitting channel state information; a resource occupied for transmitting a sounding reference signal; a resource occupied by data transmitted through a physical downlink control channel.

In an example, the idleness window is any one of the following:
a preset time length after a time point when sending of the signaling carrying the idleness information ends; a time domain resource corresponding to X consecutive time domain symbol(s) after the last time domain symbol of the signaling carrying the idleness information; a time domain resource corresponding to Y consecutive slot(s) after a slot where the last time domain symbol of the signaling carrying idleness information is located; a frequency domain resource corresponding to the preset time length after the time point when sending of the signaling carrying the idleness information ends; a frequency domain resource corresponding to the X consecutive time domain symbol(s) after the last time domain symbol of the signaling carrying the idleness information; a frequency domain resource corresponding to the Y consecutive slot(s) after the slot where the last time domain symbol of the signaling carrying the idleness information is located. In the embodiments of the present disclosure, the terminal can know at least one uplink grant-free transmission resource configured by the base station for the terminal on a bandwidth part by receiving the first signaling sent by the base station, notify the base station of the idleness window or the preset time length determined by the terminal itself, and release the idle occasion(s) in the activated uplink grant-free resource(s) based on the idleness information, so that the base station can reuse the idle occasion(s). Accordingly, the unused uplink grant-free transmission occasion(s) can be reliably and effectively reused.

Based on the same inventive concept, the present disclosure also provides a method for determining an idle occasion performed at a base station side.

FIG. 11 is a flowchart of a method for determining an idle occasion according to an example embodiment. The method is performed by a base station. As shown in FIG. 11, the method includes:

In S1101, first signaling is sent to a terminal. The first signaling is used to indicate at least one uplink grant-free transmission resource on a bandwidth part configured by the base station for the terminal.

In S1102, according to the idleness information, an idle occasion released by the terminal from a transmission occasion of at least one uplink grant-free transmission resource is determined. The idle occasion is for reuse by the base station.

An idle occasion is an idle CG PUSCH occasion. The idleness information may be used to indicate an idle occasion in an uplink grant-free transmission resource that can be released by the terminal, and/or a non-idle occasion used by the terminal for uplink transmission.

It can be understood that after receiving the uplink grant-free transmission resource(s) configured by the base station for the terminal, the terminal can perform uplink transmission in a non-idle grant-free uplink transmission occasion in the uplink grant-free transmission resource(s). At the same time, based on the idleness information, the idle occasion(s) to be released by the terminal is (are) determined, so that the base station can reuse the idle occasion(s).

The first signaling may be single signaling or a collective name for a plurality of pieces of signaling. For example, the first signaling may be single Radio Resource Control (RRC) signaling, or the first signaling may be formed by one piece of RRC signaling and one or more pieces of dynamic signaling. The dynamic signaling may, for example, carry Downlink Control Information (DCI).

In an example, the base station may first send RRC signaling to the terminal, the RRC signaling is used to indicate to the terminal a part of configuration information of at least one uplink grant-free transmission resource, and send one or more pieces of dynamic signaling to the terminal, and the dynamic signaling is used to indicate the remaining configuration information of corresponding uplink grant-free transmission resource(s) and is used to indicate the terminal to activate the corresponding uplink grant-free transmission resource(s). In a possible implementation, the idleness information may be carried through the first signaling to save signaling. For example, the base station may carry downlink control information through dynamic signaling, and the downlink control information may carry the idleness information determined by the base station. Alternatively, RRC signaling or downlink control information carrying the idleness information is separate signaling, which is not limited in the present disclosure.

There may be one or more uplink grant-free transmission resources, and the granularity of the idleness information may be in one-to-one correspondence of the uplink grant-free transmission resource(s), that is, one piece of idleness information is used to indicate an idle occasion in one uplink grant-free transmission resource, or, one piece of idleness information may be used to indicate the idle occasion(s) released in all uplink grant-free transmission resource(s).

In addition, the idleness information may be determined by the terminal. That is, the terminal determines the idle occasion(s) to be released by the terminal, and the terminal sends UCI or RRC signaling including the idleness information to the base station, or the idleness information sent by the terminal is received through PUSCH, and accordingly the base station can reuse the idle occasion(s) based on the idleness information. The UCI or RRC signaling including the idleness information may be multiplexed on the PUSCH, that is, the UCI or RRC signaling is sent through the PUSCH. Alternatively, the idleness information may also be determined by the base station, and the base station sends the idleness information to the terminal through RRC signaling or DCI to indicate the terminal to release the idle occasion(s) in the idleness information, to ensure that the base station can reliably reuse the idle occasion(s). The specific implementations have been introduced in the above corresponding embodiments at the terminal side and will not be repeated here.

One piece of idleness information may correspond to one uplink grant-free transmission resource. That is, one piece of idleness information may be used to indicate an idle occasion in one uplink grant-free transmission resource. If the base station configures a plurality of uplink grant-free transmission resources for the terminal in a bandwidth part, the idle occasion in each uplink grant-free transmission resource may be determined based on a plurality of pieces of idleness information.

In an example, the idleness information includes an occasion indication field, and the occasion indication field is used to indicate the number M of idle occasion(s) in the uplink grant-free transmission occasion(s).

The occasion indication field may include N bits, and an index value corresponding to the decimal number indicated by the N bits may be used to indicate the number M.

Taking a case where the number of bits in the occasion indication field is 2 as an example, the occasion indication field may have 00, 01, 10 and 11, corresponding to an index value 0, an index value 1, an index value 2 and an index value 3.

In an implementation, when the index value is 0, it may correspond to M which is 0. When the index value is 1, it may correspond to M which is 1. When the index value is 2, it may correspond to M which is 2. When the index value is 3, it may correspond to M which is 3. In another implementation, when the index value is 0, it may correspond to M which is 1. When the index value is 1, it may correspond to M which is 2. When the index value is 2, it may correspond to M which is 3. When the index value is 3, it may correspond to M which is 4. In another implementation, when the index value is 0, it may correspond to M which is 0 or 1. When the index value is 1, it may correspond to M which is the first power of 2. When the index value is 2, it may correspond to M which is the second power of 2 (i.e., 4). When the index value is 3, it may correspond to M which is the third power of 2 (i.e., 8). In another implementation, when the index value is 0, it may correspond to M which is 2. When the index value is 1, it may correspond to M which is 4. When the index value is 2, it may correspond to M which is 8. When the index value is 3, it may correspond to M which is 16, and so on. Those skilled in the art can calibrate the M corresponding to each index value according to actual needs, and the present disclosure does not make specific limitations on this.

When the number of bits in the occasion indication field is 1, 3 or more, the number M of occasion(s) corresponding to the occasion indication field follows a similar principle and will not be repeated here.

Optionally, in this example:
the occasion indication field is used to indicate that M transmission occasion(s) after signaling carrying the idleness information is sent is (are) idle occasion(s); or
the occasion indication field is used to indicate that the first M transmission occasion(s) in an idleness window is (are) idle occasion(s); or
the occasion indication field is used to indicate that the last M transmission occasion(s) in the idleness window is (are) idle occasion(s); or
the occasion indication field is used to indicate that M transmission occasion(s) after a preset time length after the signaling carrying the idleness information is sent is (are) idle occasion(s);
the idleness window corresponds to a time domain resource and/or a frequency domain resource, and the candidate preset time length corresponds to a time domain resource.

It can be understood that the signaling carrying the idleness information when the idleness information is determined by the terminal is different from the signaling carrying the idleness information when the idleness information is determined by the base station. In addition, the idleness window may be used to indicate a time range, and the idleness window may be described by the number of symbols, the number of slots, or a time length. The preset time length may be an absolute time length.

The idleness window may be an independent time domain concept or a time-frequency domain concept. When the idleness window is the time-frequency domain concept, the idleness window may occupy one or more RBs, or a carrier, or a band, or a BWP, etc. in the frequency domain, which is not limited in the present disclosure.

In addition, the idleness window and the preset time length may be indicated by the base station, or may be notified by the terminal to the base station, or may be configured to the terminal by the base station through higher layer signaling. Specifically, the base station may perform any one of the following steps: receiving an idleness window or a preset time length sent by the terminal, where the idleness window or the preset time length is determined based on a capability of the terminal, or is determined from at least one candidate idleness window or at least one candidate preset time length, and the at least one candidate idleness window or the at least one candidate preset time length is configured by the base station for the terminal; sending, to the terminal, an idleness window or a preset time length configured for the terminal.

Specifically, how to make the base station and the terminal reach a consensus on the idleness window and the preset time length has been introduced in the above-mentioned corresponding method embodiments at the terminal side, which will not be repeated here.

In another example, the idleness information includes an idleness window and an occasion indication field, the occasion indication field includes N bits, and each bit is used to indicate whether a corresponding transmission occasion in the idleness window is idle.

The idleness information may specifically include information about the number of idleness window(s), time information of the idleness window(s), such as the number of symbols or the number of slots, and/or information about the number of transmission occasion(s) in the idleness window(s), etc. The idleness information may include one or more idleness windows.

For example, if the idleness information indicates that there are 10 idleness windows in the current uplink grant-free transmission resource(s), if the occasion indication field includes 10 bits, when any one bit is 1, it may indicate that the transmission occasion(s) in the idleness window corresponding to the bit is (are) idle occasion(s); when any one bit is 0, it can indicate that the transmission occasion(s) in the idleness window corresponding to the bit is (are) non-idle occasion(s).

In an example, the idleness window includes N idleness sub-window(s), and each bit of the N bits is further used to indicate whether transmission occasion(s) in the idleness sub-window is (are) idle.

For example, if the length of an idleness window is W (W may be the number of symbols or the number of slots), the idleness window may be divided into N idleness sub-window(s). Specifically, the granularity of the first ┌W/N┐*N−W idleness sub-windows is └W/N┘, and the granularity of the last N+W−┌W/N┐*N idleness sub-windows is ┌W/N┐. Alternatively, the granularity of the firstW−└W/N┘*N idleness sub-windows is ┌W/N┐, and the granularity of the last N−W+┌W/N┐*N idleness sub-windows is └W/N┘.

For example, if the length of an idleness window is 20 symbols and the occasion indication field includes 8 bits, the idleness window may be divided as follows: the granularity of the first 4 idleness sub-windows is 2 symbols and the granularity of the last 4 idleness sub-windows is 3 symbols. If any one bit in the occasion indication field is 1, it may indicate that the transmission occasion(s) in the idleness sub-window corresponding to the bit is (are) idle occasion(s). If any one bit is 0, it may indicate that the transmission occasion(s) in the idleness sub-window corresponding to the bit is (are) non-idle occasion(s). For example, if the occasion indication field is 00001111, the idleness information may indicate that the transmission occasions in the first 8 symbols in the idleness window are non-idle occasions, and the transmission occasions in the last 12 symbols are all idle occasions.

In another example, the transmission occasion(s) in the idleness window includes (include) N transmission occasion group(s), and each of the N bits is further used to indicate whether a transmission occasion group is idle. For example, if the idleness window includes W transmission occasions, the plurality of transmission occasions in the idleness window are divided into N transmission occasion groups. Specifically, the granularity of the first ┌W/N┐*N−W transmission occasion groups is └W/N┘, and the granularity of the last N+W−┌W/N┐*N transmission occasion groups is ┌W/N┐. Alternatively, the granularity of the first W−└W/N┘*N transmission occasion groups is ┌W/N┐, and the granularity of the last N−W+┌W/N┐*N transmission occasion groups is └W/N┘.

For example, if the number of transmission occasions is 20, and the occasion indication field includes 8 bits, the plurality of transmission occasions may be divided, and the granularity of the first 4 transmission occasion groups is 2 transmission occasions, and the granularity of the last 4 transmission occasion groups is 3 transmission occasions. If any one bit in the occasion indication field is 1, it may indicate that the transmission occasion(s) in the transmission occasion group corresponding to the bit is (are) idle occasion(s). When any one bit is 0, it may indicate that the transmission occasion(s) of the transmission occasion group corresponding to the bit is (are) non-idle occasion(s). For example, if the occasion indication field is 00001111, the idleness information may indicate that the first 4*2 transmission occasions in the idleness window are non-idle occasions, and the last 4*3 transmission occasions are all idle occasions.

In yet another example, the idleness information includes an occasion indication granularity and the occasion indication field;
the occasion indication granularity is used to indicate a time period, where the time period is indicated by the number of symbols, or by the number of slots, or by a time length;
the occasion indication field includes N bits, and each bit is used to indicate whether transmission occasion(s) within an occasion indication granularity is (are) idle.

The starting time of a time period indicated by the first bit of the occasion indication field may be a time point when sending of the signaling carrying the idleness information ends, or the first symbol after the last time domain symbol of the signaling carrying the idleness information, or the first slot after a slot where the last time domain symbol of the signaling carrying the idleness information is located.

For example, in a case where the time period indicated by the occasion indication granularity is 2 symbols and the occasion indication field includes 8 bits, if the occasion indication field is 00001111, the idleness information may indicate that all transmission occasions in the first 4*2 symbols are non-idle occasions, and all transmission occasions in the last 4*2 symbols are idle occasions.

In yet another example, the idleness information includes an idleness window, and the idleness window is used to indicate that all transmission occasions within the idleness window are idle occasions.

In another example, the idleness information includes the occasion indication field, the occasion indication field includes N bits, and each bit is used to indicate whether a transmission occasion in an uplink grant-free transmission resource corresponding to the bit in the at least one uplink grant-free transmission resource is idle.

For example, if the base station configures 8 sets of uplink grant-free transmission resources for the terminal, the occasion indication field may include 8 bits. If the occasion indication field is 00001111, it may indicate that the transmission occasions in the first 4 sets of uplink grant-free transmission resources are non-idle occasions, and the transmission occasions in the last 4 sets of uplink grant-free transmission resources are all idle occasions.

In an example, the idleness window does not include at least one of the following:
a downlink resource used for downlink data transmission; a flexible resource that is not configured with an uplink or downlink data transmission attribute; a resource occupied for transmitting a synchronization signal and physical broadcast channel; a resource occupied by data transmitted through a physical downlink shared channel; a resource occupied for transmitting channel state information; a resource occupied for transmitting a sounding reference signal; a resource occupied by data transmitted through a physical downlink control channel.

Specifically, the idleness window skips at least one of the above time domain resources and/or frequency domain resources. That is to say, when determining the idleness window, the base station or terminal needs to skip the above time domain resources and/or frequency domain resources. This can avoid a situation where transmission occasion(s) in an idleness window is (are) non-idle occasion(s). In an example, the idleness window is any one of the following:
a preset time length after a time point when sending of the signaling carrying the idleness information ends; a time domain resource corresponding to X consecutive time domain symbol(s) after the last time domain symbol of the signaling carrying the idleness information; a time domain resource corresponding to Y consecutive slot(s) after a slot where the last time domain symbol of the signaling carrying idleness information is located; a frequency domain resource corresponding to the preset time length after the time point when sending of the signaling carrying the idleness information ends; a frequency domain resource corresponding to the X consecutive time domain symbol(s) after the last time domain symbol of the signaling carrying idleness information; a frequency domain resource corresponding to the Y consecutive slot(s) after the slot where the last time domain symbol of the signaling carrying idleness information is located. It can be understood that the signaling carrying the idleness information when the idleness information is determined by the terminal is different from the signaling carrying the idleness information when the idleness information is determined by the base station. Therefore, the above-mentioned signaling sending end time point, the last time domain symbol for sending the signaling, and the slot where the last time domain symbol for sending the signaling is located can be specifically determined based on the device that sends the idleness information.

In the embodiments of the present disclosure, the terminal receives the first signaling sent by the base station to know at least one uplink grant-free transmission resource on a bandwidth part configured by the base station for the terminal, and further determines, based on the idleness information, idle occasion(s) released from the transmission occasion of the at least one uplink grant-free transmission resource, and then releases the idle occasion(s), so that the base station can reuse the idle occasion(s). Accordingly, the unused uplink grant-free transmission occasion(s) can be reliably and effectively reused.

FIG. 12 is a flowchart of a method for determining an idle occasion according to an example embodiment. The method is performed by a base station. As shown in FIG. 12, the method includes:

In S1201, first signaling is sent to a terminal. The first signaling is used to indicate at least one uplink grant-free transmission resource on a bandwidth part configured by the base station for the terminal. The terminal is configured to determine an idle occasion released from a transmission occasion of the at least one uplink grant-free transmission resource according to idleness information. The idle occasion is for reuse by the base station.

In S1202, according to the idleness information, the idle occasion released by the terminal from the transmission occasion of the at least one uplink grant-free transmission resource is determined. The idle occasion is for reuse by the base station.

In S1203, the idleness information is sent to other terminal(s) communicating with the base station through RRC signaling or downlink control information.

The idle occasion is an idle CG PUSCH occasion. The idleness information may be used to indicate an idle occasion in an uplink grant-free transmission resource that can be released by the terminal, and/or a non-idle occasion used by the terminal for uplink transmission.

The first signaling may be single signaling or a collective name for a plurality of pieces of signaling. For example, the first signaling may be single Radio Resource Control (RRC) signaling, or the first signaling may be formed by one piece of RRC signaling and one or more pieces of dynamic signaling. The dynamic signaling may carry Downlink Control Information (DCI) for example. In a possible implementation, the idleness information may be carried by the first signaling to save signaling. For example, the base station may carry downlink control information through dynamic signaling, and the downlink control information may carry the idleness information determined by the base station. Alternatively, RRC signaling or downlink control information carrying the idleness information is separate signaling, which is not limited in the present disclosure.

In addition, the idleness information may be determined by the terminal. That is, the terminal determines the idle occasion(s) to be released and notifies the base station of the idle occasion(s), so as to reuse the idle occasion(s), such as the embodiment shown in FIG. 3 or FIG. 4. Alternatively, the idleness information may be determined by the base station, and the base station indicates the terminal to release the idle occasion(s) to ensure that the base station can reliably reuse the idle occasion(s), such as the embodiment shown in FIG. 5. The specific implementations have been introduced in the above-mentioned embodiments at the terminal side and will not be repeated here.

One piece of idleness information may correspond to one uplink grant-free transmission resource. That is, one piece of idleness information may be used to indicate an idle occasion in one uplink grant-free transmission resource. If the base station configures a plurality of uplink grant-free transmission resources for the terminal in a bandwidth part, the idle occasion in each uplink grant-free transmission resource may be determined based on a plurality of pieces of idleness information.

In an example, the idleness information includes an occasion indication field, and the occasion indication field is used to indicate the number M of idle occasion(s) in the uplink grant-free transmission occasion(s).

Optionally, in this example:
the occasion indication field is used to indicate that M transmission occasion(s) after signaling carrying the idleness information is sent is (are) idle occasion(s); or
the occasion indication field is used to indicate that the first M transmission occasion(s) in an idleness window is (are) idle occasion(s); or
the occasion indication field is used to indicate that the last M transmission occasion(s) in the idleness window is (are) idle occasion(s); or
the occasion indication field is used to indicate that M transmission occasion(s) after a preset time length after the signaling carrying the idleness information is sent is (are) idle occasion(s);
the idleness window corresponds to a time domain resource and/or a frequency domain resource, and the candidate preset time length corresponds to a time domain resource.

It is understandable that the signaling carrying the idleness information when the idleness information is determined by the terminal is different from the signaling carrying the idleness information when the idleness information is determined by the base station. In addition, the idleness window may be used to indicate a time range, and the idleness window may be described by the number of symbols, the number of slots, or a time length. The preset time length may be an absolute time length.

The idleness window may be an independent time domain concept or a time-frequency domain concept. When the idleness window is the time-frequency domain concept, the idleness window may occupy one or more Radio Bearers (RBs), or a carrier, or a band, or a BWP, etc. in the frequency domain, and the present disclosure does not limit this.

In another example, the idleness information includes an idleness window and an occasion indication field, the occasion indication field includes N bits, and each bit is used to indicate whether a corresponding transmission occasion in the idleness window is idle.

The idleness information may specifically include information about the number of idleness window(s), time information of the idleness window(s), such as the number of symbols or the number of slots, and/or information about the number of transmission occasion(s) in the idleness window(s), etc. The idleness information may include one or more idleness windows.

In an example, the idleness window includes N idleness sub-window(s), and each of the N bits is further used to indicate whether transmission occasion(s) in the idleness sub-window is (are) idle.

For example, if the length of an idleness window is W (W may be the number of symbols or the number of slots), the idleness window may be divided into N idleness sub-window(s). Specifically, the granularity of the first ┌W/N┐*N−W idleness sub-windows is └W/N┘, and the granularity of the last N+W−┌W/N┐*N idleness sub-windows is ┌W/N┐. Alternatively, the granularity of the first W−└W/N┘*N idleness sub-windows is ┌W/N┐, and the granularity of the last N−W+┌W/N┐*N idleness sub-windows is └W/N┘.

In another example, the transmission occasion(s) in the idleness window includes (include) N transmission occasion group(s), and each of the N bits is further used to indicate whether a transmission occasion group is idle.

For example, if the idleness window includes W transmission occasions, the plurality of transmission occasions in the idleness window are divided into N transmission occasion groups. Specifically, the granularity of the first ┌W/N┐*N−W transmission occasion groups is └W/N┘, and the granularity of the last N+W−┌W/N┐*N transmission occasion groups is ┌W/N┐. Alternatively, the granularity of the first W−└W/N┘*N transmission occasion groups is ┌W/N┐, and the granularity of the last N−W+┌W/N┐*N transmission occasion groups is └W/N┘.

In yet another example, the idleness information includes an occasion indication granularity and an occasion indication field;
the occasion indication granularity is used to indicate a time period, where the time period is indicated by the number of symbols, or by the number of slots, or by a time length;
the occasion indication field includes N bits, and each bit is used to indicate whether transmission occasion(s) within an occasion indication granularity is (are) idle.

The starting time of a time period indicated by the first bit of the occasion indication field may be a time point when sending of the signaling carrying the idleness information ends, or the first symbol after the last time domain symbol of the signaling carrying the idleness information, or the first slot after a slot where the last time domain symbol of the signaling carrying the idleness information is located.

In yet another example, the idleness information includes an idleness window, and the idleness window is used to indicate that all transmission occasions within the idleness window are idle occasions.

In another example, the idleness information includes the occasion indication field, the occasion indication field includes N bits, and each bit is used to indicate whether a transmission occasion in an uplink grant-free transmission resource corresponding to the bit in the at least one uplink grant-free transmission resource is idle.

In an example, the idleness window does not include at least one of the following:
a downlink resources used for downlink data transmission; a flexible resource that is not configured with an uplink or downlink data transmission attribute; a resource occupied for transmitting a synchronization signal and physical broadcast channel; a resource occupied by data transmitted through a physical downlink shared channel; a resource occupied for transmitting channel state information; a resource occupied for transmitting a sounding reference signal; a resource occupied by data transmitted through a physical downlink control channel.

In an example, the idleness window is any one of the following:
a preset time length after a time point when sending of the signaling carrying the idleness information ends; a time domain resource corresponding to X consecutive time domain symbol(s) after the last time domain symbol of the signaling carrying the idleness information; a time domain resource corresponding to Y consecutive slot(s) after a slot where the last time domain symbol of the signaling carrying idleness information is located; a frequency domain resource corresponding to the preset time length after the time point when sending of the signaling carrying the idleness information ends; a frequency domain resource corresponding to the X consecutive time domain symbol(s) after the last time domain symbol of the signaling carrying idleness information; a frequency domain resource corresponding to the Y consecutive slot(s) after the slot where the last time domain symbol of the signaling carrying idleness information is located. In the embodiments of the present disclosure, the terminal receives the first signaling sent by the base station to know least one uplink grant-free transmission resource on a bandwidth part configured by the base station for the terminal, and the terminal determines the idleness information corresponding to the uplink grant-free transmission resource and notifies the base station of the idleness information, and further releases the idle occasion(s) based on the idleness information determined by the terminal, so that the base station can reuse the idle occasion(s). And, the idleness information is sent to other terminal(s) communicating with the base station, so that other terminal(s) can know the idle occasion(s) released by the current terminal, and accordingly the unused uplink grant-free transmission occasion(s) can be reliably and effectively reused.

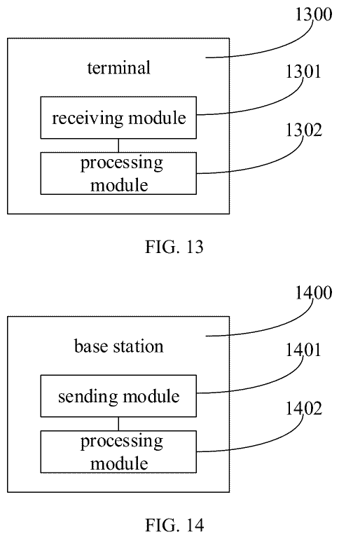

FIG. 13 is a block diagram of a terminal according to an example embodiment. As shown in FIG. 13, the terminal 1300 includes:
a receiving module 1301 configured to receive first signaling sent by a base station, where the first signaling is used to indicate at least one uplink grant-free transmission resource on a bandwidth part configured by the base station for the terminal;
a release module 1302 configured to determine, according to idleness information, an idle occasion released from a transmission occasion of the at least one uplink grant-free transmission resource, where the idle occasion is for reuse by the base station.

Optionally, the terminal 1300 includes:
a first sending module configured to: send uplink control information or RRC signaling to the base station, where the uplink control information or the RRC signaling carries the idleness information; or, carry the idleness information through a physical uplink shared channel.

Optionally, the Uplink Control Information (UCI) or RRC signaling is multiplexed on the physical uplink shared channel.

Optionally, the terminal 1300 includes:
a first receiving module configured to receive the idleness information sent by the base station through RRC signaling or downlink control information.

Optionally, the receiving module 1 301 is configured to:
receive RRC signaling sent by the base station, where the RRC signaling is used to indicate, to the terminal, all configuration information of the uplink grant-free transmission resource.

Optionally, the receiving module 1 301 is configured to:
receive RRC signaling sent by the base station, where the RRC signaling is used to indicate, to the terminal, a part of configuration information of the uplink grant-free transmission resource; and
receive dynamic signaling sent by the base station, where the dynamic signaling is used to indicate, to the terminal, the remaining configuration information of an uplink grant-free transmission resource and to indicate the terminal to activate the uplink grant-free transmission resource.

Optionally, the idleness information includes an occasion indication field, and the occasion indication field is used to indicate the number M of idle occasion(s) in uplink grant-free transmission occasion(s).

Optionally, the occasion indication field indicate that M transmission occasion(s) after signaling carrying the idleness information is sent is (are) idle occasion(s); or
the occasion indication field is used to indicate that the first M transmission occasion(s) in an idleness window is (are) idle occasion(s); or
the occasion indication field is used to indicate that the last M transmission occasion(s) in the idleness window is (are) idle occasion(s); or
the occasion indication field is used to indicate that M transmission occasion(s) after a preset time length after the signaling carrying the idleness information is sent is (are) idle occasion(s);
the idleness window corresponds to a time domain resource and/or a frequency domain resource, and the candidate preset time length corresponds to a time domain resource.

Optionally, the terminal 1300 includes:
a first sending module configured to send an idleness window or a preset time length to the base station, where the idleness window or the preset time length is determined according to a capability of the terminal, or is determined from at least one candidate idleness window or at least one candidate preset time length, and the at least one candidate idleness window or the at least one candidate preset time length is configured by the base station for the terminal; or
a second module configured to receive an idleness window or a preset time length configured by the base station for the terminal.

Optionally, the idleness information includes an idleness window and an occasion indication field, the occasion indication field includes N bits, and each bit of the N bits is used to indicate whether a corresponding transmission occasion in the idleness window is idle; or
the idleness information includes an idleness window, and the idleness window is used to indicate that all transmission occasions within the idleness window are idle occasions; or
the idleness information includes an occasion indication field, the occasion indication field includes N bits, each bit is used to indicate whether a transmission occasion in an uplink grant-free transmission resource corresponding to the bit in the at least one uplink grant-free transmission resource is idle; or
the idleness information includes an occasion indication granularity and an occasion indication field, where the occasion indication granularity is used to indicate a time period, the time period is indicated by the number of symbols, the number of slots, or a time length, the occasion indication field includes N bits, and each bit is used to indicate whether a transmission occasion within an occasion indication granularity is idle.

Optionally, the idleness window includes N idleness sub-windows, and each bit in the N bits is further used to indicate whether a transmission occasion in an idleness sub-window is idle; or
the transmission occasion in the idleness window includes N transmission occasion groups, and each bit in the N bits is further used to indicate whether a transmission occasion group is idle. Optionally, the idleness window does not include at least one of the following:
a downlink resource used for downlink data transmission; a flexible resource that is not configured with an uplink or downlink data transmission attribute; a resource occupied for transmitting a synchronization signal and physical broadcast channel; a resource occupied by data transmitted through a physical downlink shared channel; a resource occupied for transmitting channel state information; a resource occupied for transmitting a sounding reference signal; a resource occupied by data transmitted through a physical downlink control channel.

Optionally, the idleness window is any one of the following:
a preset time length after a time point when sending of the signaling carrying the idleness information ends; a time domain resource corresponding to X consecutive time domain symbol(s) after the last time domain symbol of the signaling carrying the idleness information; a time domain resource corresponding to Y consecutive slot(s) after a slot where the last time domain symbol of the signaling carrying idleness information is located; a frequency domain resource corresponding to the preset time length after the time point when sending of the signaling carrying the idleness information ends; a frequency domain resource corresponding to the X consecutive time domain symbol(s) after the last time domain symbol of the signaling carrying idleness information; a frequency domain resource corresponding to the Y consecutive slot(s) after the slot where the last time domain symbol of the signaling carrying idleness information is located. FIG. 14 is a block diagram of a base station according to an example embodiment. As shown in FIG. 14, the base station 1400 includes:
a sending module 1401 configured to send first signaling to a terminal, where the first signaling is used to indicate at least one uplink grant-free transmission resource on a bandwidth part configured by the base station for the terminal; and
a processing module 1402 configured to determine, according to idleness information, an idle occasion released from a transmission occasion of the at least one uplink grant-free transmission resource, where the idle occasion is for reuse by the base station.

Optionally, the base station 1400 includes:
a first receiving module configured to receive uplink control information sent by the terminal, where the uplink control information or RRC signaling carries the idleness information, or, the idleness information is carried through a physical uplink shared channel.

Optionally, the uplink control information or RRC signaling is multiplexed on the physical uplink shared channel.

Optionally, the base station 1400 includes:
a first sending module configured to send idleness information through RRC signaling or downlink control information.

Optionally, the sending module 1 401 is configured to:
send RRC signaling to the terminal, where the RRC signaling is used to indicate, to the terminal, all configuration information of the uplink grant-free transmission resource(s).

Optionally, the sending module 1 401 is configured to:
send RRC signaling to the terminal, where the RRC signaling is used to indicate, to the terminal, a part of configuration information of uplink grant-free transmission resource(s); and
send dynamic signaling to the terminal, where the dynamic signaling is used to indicate, to the terminal, the remaining configuration information of an uplink grant-free transmission resource and to indicate the terminal to activate the uplink grant-free transmission resource.

Optionally, the idleness information includes an occasion indication field, and the occasion indication field is used to indicate the number M of idle occasion(s) in the uplink grant-free transmission occasion(s).

Optionally, the occasion indication field is used to indicate that M transmission occasion(s) after signaling carrying the idleness information is sent is (are) idle occasion(s); or
the occasion indication field is used to indicate that the first M transmission occasion(s) in an idleness window is (are) idle occasion(s); or
the occasion indication field is used to indicate that the last M transmission occasion(s) in the idleness window is (are) idle occasion(s); or
the occasion indication field is used to indicate that M transmission occasion(s) after a preset time length after the signaling carrying the idleness information is sent is (are) idle occasion(s);
the idleness window corresponds to a time domain resource and/or a frequency domain resource, and the candidate preset time length corresponds to a time domain resource.

Optionally, the base station 1400 includes:
a second receiving module configured to receive an idleness window or a preset time length sent by the terminal, where the idleness window or the preset time length is determined according to a capability of the terminal, or the idleness window or the preset time length is determined from at least one candidate idleness window or at least one candidate preset time length, and the at least one candidate idleness window or the at least one candidate preset time length is configured by the base station for the terminal; or
a second sending module configured to send to the terminal the idleness window or preset time length configured by the base station for the terminal.

Optionally, the idleness information includes an idleness window and an occasion indication field, the occasion indication field includes N bits, and each bit is used to indicate whether a corresponding transmission occasion in the idleness window is idle.

Optionally, the idleness information includes an idleness window and an occasion indication field, the occasion indication field includes N bits, and each bit of the N bits is used to indicate whether a corresponding transmission occasion in the idleness window is idle; or
the idleness information includes an idleness window, and the idleness window is used to indicate that all transmission occasions within the idleness window are idle occasions; or
the idleness information includes an occasion indication field, the occasion indication field includes N bits, each bit is used to indicate whether a transmission occasion in an uplink grant-free transmission resource corresponding to the bit in the at least one uplink grant-free transmission resource is idle; or
the idleness information includes an occasion indication granularity and an occasion indication field, the occasion indication granularity is used to indicate a time period, the time period is indicated by the number of symbols, the number of slots or a time length, the occasion indication field includes N bits, and each bit of the N bits is used to indicate whether a transmission occasion within an occasion indication granularity is idle.

Optionally, the idleness window includes N idleness sub-windows, and each bit in the N bits is further used to indicate whether a transmission occasion in an idleness sub-window is idle; or
the transmission occasion in the idleness window includes N transmission occasion groups, and each of the N bits is further used to indicate whether a transmission occasion group is idle.

Optionally, the idleness window does not include at least one of the following:
a downlink resource used for downlink data transmission; a flexible resource that is not configured with an uplink or downlink data transmission attribute; a resource occupied for transmitting a synchronization signal and physical broadcast channel; a resource occupied by data transmitted through a physical downlink shared channel; a resource occupied for transmitting channel state information; a resource occupied for transmitting a sounding reference signal; a resource occupied by data transmitted through a physical downlink control channel.

Optionally, the idleness window is any one of the following:
a preset time length after a time point when sending of the signaling carrying the idleness information ends; a time domain resource corresponding to X consecutive time domain symbol(s) after the last time domain symbol of the signaling carrying the idleness information; a time domain resource corresponding to Y consecutive slot(s) after a slot where the last time domain symbol of the signaling carrying idleness information is located; a frequency domain resource corresponding to the preset time length after the time point when sending of the signaling carrying the idleness information ends; a frequency domain resource corresponding to the X consecutive time domain symbol(s) after the last time domain symbol of the signaling carrying idleness information; a frequency domain resource corresponding to the Y consecutive slot(s) after the slot where the last time domain symbol of the signaling carrying idleness information is located. Optionally, the base station 1400 includes:
a third sending module configured to send the idleness information to other terminal(s) communicating with the base station, where the idleness information is carried through Radio Resource Control (RRC) signaling or downlink control information.

Regarding the apparatuses in the above embodiments, the specific manner in which each module performs the operations has been described in detail in the embodiments of the methods, and will not be elaborated here.

The present disclosure also provides a computer-readable storage medium having computer program instructions stored thereon. When the program instructions are executed by a processor, the steps of the method for determining an idle occasion provided by the present disclosure are implemented

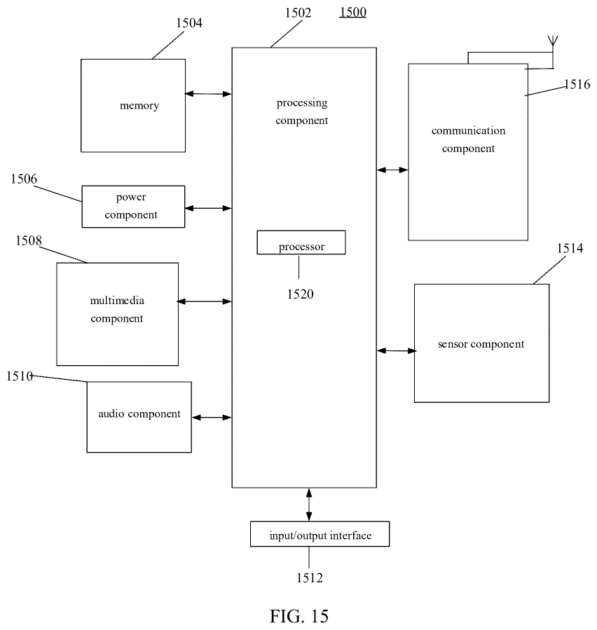

FIG. 15 is a block diagram of a communication apparatus 1500 according to an example embodiment. The communication apparatus 1500 may be provided as a terminal. Referring to FIG. 15, the communication apparatus 1500 may include one or more of the following components: a processing component 1502, a memory 1504, a power component 1506, a multimedia component 1508, an audio component 1510, an input/output (I/O) interface 1512, a sensor component 1514, and a communication component 1516.

The processing component 1502 typically controls overall operations of the communication apparatus 1500, such as the operations associated with display, telephone calls, data communications, camera operations, and recording operations. The processing component 1502 may include one or more processors 1520 to execute instructions to perform all or part of the steps in the above described methods for determining an idle occasion. Moreover, the processing component 1502 may include one or more modules which facilitate the interaction between the processing component 1502 and other components. For instance, the processing component 1502 may include a multimedia module to facilitate the interaction between the multimedia component 1508 and the processing component 1502.

The memory 1504 is configured to store various types of data to support the operation of the communication apparatus 1500. Examples of such data include instructions for any applications or methods for determining an idle occasion operated on the communication apparatus 1500, contact data, phonebook data, messages, pictures, video, etc. The memory 1504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1506 provides power to various components of the communication apparatus 1500. The power component 1506 may include a power management system, one or more power sources, and any other components associated with the generation, management, and distribution of power in the communication apparatus 1500.

The multimedia component 1508 includes a screen providing an output interface between the communication apparatus 1500 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1508 includes a front camera and/or a rear camera. The front camera and the rear camera may receive an external multimedia datum while the communication apparatus 1500 is in an operation mode, such as a photographing mode or a video mode. Each of the front camera and the rear camera may be a fixed optical lens system or have focus and optical zoom capability.

The audio component 1510 is configured to output and/or input audio signals. For example, the audio component 1510 includes a microphone (“MIC”) configured to receive an external audio signal when the communication apparatus 1500 is in an operation mode, such as a call mode, a recording mode, and a voice recognition mode. The received audio signal may be further stored in the memory 1504 or transmitted via the communication component 1516. In some embodiments, the audio component 1510 further includes a speaker to output audio signals.

The I/O interface 1512 provides an interface between the processing component 1502 and peripheral interface modules, such as a keyboard, a click wheel, buttons, and the like. The buttons may include, but are not limited to, a home button, a volume button, a starting button, and a locking button.

The sensor component 1514 includes one or more sensors to provide status assessments of various aspects of the communication apparatus 1500. For instance, the sensor component 1514 may detect an open/closed status of the communication apparatus 1500, relative positioning of components, e.g., the display and the keypad, of the communication apparatus 1500, a change in position of the communication apparatus 1500 or a component of the communication apparatus 1500, a presence or absence of user contact with the communication apparatus 1500, an orientation or an acceleration/deceleration of the communication apparatus 1500, and a change in temperature of the communication apparatus 1500. The sensor component 1514 may include a proximity sensor configured to detect the presence of nearby objects without any physical contact. The sensor component 1514 may also include a light sensor, such as a CMOS or CCD image sensor, for use in imaging applications. In some embodiments, the sensor component 1514 may also include an accelerometer sensor, a gyroscope sensor, a magnetic sensor, a pressure sensor, or a temperature sensor.

The communication component 1516 is configured to facilitate communication, wired or wirelessly, between the communication apparatus 1500 and other devices. The communication apparatus 1500 can access a wireless network based on a communication standard, such as WiFi, 2G, or 3G, or a combination thereof. In one example embodiment, the communication component 1516 receives a broadcast signal or broadcast associated information from an external broadcast management system via a broadcast channel. In one example embodiment, the communication component 1516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the communication apparatus 1500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods for determining an idle occasion.

In example embodiments, there is also provided a non-transitory computer-readable storage medium including instructions, such as the memory 1504 including instructions executable by the processor 1520 in the communication apparatus 1500, for performing the above-described methods for determining an idle occasion. For example, the non-transitory computer-readable storage medium may be a ROM, a Random Access Memory (RAM), a CD-ROM, a magnetic tape, a floppy disc, an optical data storage device, and the like.

In another example embodiment, a computer program product is further provided. The computer program product includes a computer program executable by a programmable apparatus. The computer program has a code portion for implementing the above-mentioned method for determining an idle occasion when executed by the programmable apparatus.

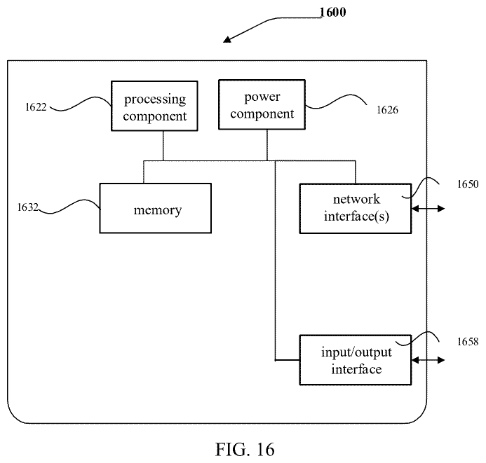

FIG. 16 is a block diagram of a communication apparatus according to an example embodiment. For example, the communication apparatus 1600 may be provided as an access network device, such as a base station. Referring to FIG. 16, the communication apparatus 1600 includes a processing component 1622 that further includes one or more processors, and memory resources represented by a memory 1632 for storing instructions executable by the processing component 1622, such as application programs. The application programs stored in the memory 1632 may include one or more modules each corresponding to a set of instructions. Further, the processing component 1622 is configured to execute the instructions to perform steps of the methods for determining an idle occasion provided in the method embodiments.

The communication apparatus 1600 may also include a power component 1626 configured to perform power management of the communication apparatus 1600, wired or wireless network interface(s) 1650 configured to connect the communication apparatus 1600 to a network, and an input/output (I/O) interface 1658. The communication apparatus 1600 may operate based on an operating system stored in the memory 1632, such as Windows Server™, Mac OS X™, Unix™, Linux™, FreeBSD™, or the like.

In another example embodiment, a computer program product is further provided. The computer program product includes a computer program executable by a programmable apparatus. The computer program has a code portion for implementing the above-mentioned methods for determining an idle occasion when executed by the programmable apparatus.

Other embodiments of the present disclosure will be apparent to those skilled in the art from consideration of the description and practice of the present disclosure. This application is intended to cover any variations, uses, or adaptations of the present disclosure following the general principles thereof and including such departures from the present disclosure as come within known or customary practice in the art. It is intended that the description and examples be considered as illustrative only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method for determining an idle occasion, wherein the method is performed by a terminal, and the method comprises:
receiving first signaling sent by a base station, wherein the first signaling is used to indicate at least one uplink grant-free transmission resource on a bandwidth part configured by the base station for the terminal; and
according to idleness information, determining an idle occasion released from a transmission occasion of the at least one uplink grant-free transmission resource, wherein the idle occasion is for reuse by the base station.

2. The method according to claim 1, further comprising:
sending Uplink Control Information (UCI) or Radio Resource Control (RRC) signaling to the base station, wherein the UCI or the RRC signaling comprises the idleness information; or
sending the idleness information to the base station through a Physical Uplink Shared Channel (PUSCH).

3. The method according to claim 2, wherein the UCI or the RRC signaling is multiplexed in the PUSCH.

4. The method according to claim 1, wherein the method comprises:
receiving the idleness information sent by the base station through RRC signaling or Downlink Control Information (DCI).

5. The method according to claim 1, wherein receiving the first signaling sent by the base station comprises:
receiving RRC signaling sent by the base station, wherein the RRC signaling is used to indicate, to the terminal, all configuration information for the at least one uplink grant-free transmission resource; or
wherein receiving the first signaling sent by the base station comprises:
receiving RRC signaling sent by the base station, wherein the RRC signaling is used to indicate, to the terminal, a part of configuration information for the at least one uplink grant-free transmission resource;
wherein the method further comprises:
receiving dynamic signaling sent by the base station, wherein the dynamic signaling is used to indicate remaining configuration information for one or more of the at least one uplink grant-free transmission resource and to indicate the terminal to activate the one or more of the at least one uplink grant-free transmission resource.

6. The method according to claim 1, wherein the idleness information comprises an occasion indication field, and the occasion indication field is used to indicate the number M of idle occasions in the transmission occasion.

7. The method according to claim 6, wherein:
the occasion indication field is further used to indicate that M transmission occasions after signaling carrying the idleness information is sent are idle occasions; or
the occasion indication field is further used to indicate that first M transmission occasions in an idleness window are the idle occasions; or
the occasion indication field is further used to indicate that last M transmission occasions in the idleness window are the idle occasions; or
the occasion indication field is further used to indicate that M transmission occasions after a preset time length after the signaling carrying the idleness information is sent are the idle occasions;
wherein the idleness window corresponds to at least one of a time domain resource or a frequency domain resource, and the preset time length corresponds to a time domain resource.

8. The method according to claim 7, further comprising one of:
sending the idleness window or the preset time length to the base station, wherein the idleness window or the preset time length is determined according to a capability of the terminal, or is determined from at least one candidate idleness window or at least one candidate preset time length, wherein the at least one candidate idleness window or the at least one candidate preset time length is configured by the base station for the terminal; and
receiving the idleness window or the preset time length configured by the base station for the terminal.

9. The method according to claim 1, wherein:
the idleness information comprises an idleness window and an occasion indication field, the occasion indication field comprises N bits, and each bit of the N bits is used to indicate whether a corresponding transmission occasion in the idleness window is idle; or
the idleness information comprises the idleness window, and the idleness window is used to indicate that all transmission occasions in the idleness window are idle occasions; or
the idleness information comprises the occasion indication field, the occasion indication field comprises N bits, each of the N bits is used to indicate whether a transmission occasion of an uplink grant-free transmission resource corresponding to the bit in the at least one uplink grant-free transmission resource is idle; or
the idleness information comprises an occasion indication granularity and the occasion indication field, the occasion indication granularity is used to indicate a time period, and the time period is indicated by the number of symbols or the number of slots or a time length, the occasion indication field comprises N bits, and each bit is used to indicate whether a transmission occasion in an occasion indication granularity is idle.

10. The method according to claim 9, wherein:
the idleness window comprises N idleness sub-windows, and each bit in the N bits is further used to indicate whether a transmission occasion in an idleness sub-window is idle; or
a transmission occasion in the idleness window comprises N transmission occasion groups, and each bit in the N bits is further used to indicate whether a transmission occasion group is idle.

11. The method according to claim 7, wherein the idleness window does not comprise at least one of:
a downlink resource for downlink data transmission;
a flexible resource that is not configured with an uplink or downlink data transmission attribute;
a resource occupied for transmitting a Synchronization Signal and Physical Broadcast Channel (SS/PBCH);
a resource occupied by data transmitted through a Physical Downlink Shared Channel (PDSCH);
a resource occupied for transmitting Channel State Information (CSI);
a resource occupied for transmitting a Sounding Reference Signal (SRS);
a resource occupied by data transmitted through a Physical Downlink Control Channel (PDCCH).

12. The method according to claim 7, wherein the idleness window is any one of:
a preset time length after a time point when sending of the signaling carrying the idleness information ends;
a time domain resources corresponding to X consecutive time domain symbols after the last time domain symbol of the signaling carrying the idleness information;
a time domain resources corresponding to Y consecutive slots after a slot where the last time domain symbol of the signaling carrying the idleness information is located;
a frequency domain resource corresponding to the preset time length after the time point when sending of the signaling carrying the idleness information ends;
a frequency domain resource corresponding to the X consecutive time domain symbols after the last time domain symbol of the signaling carrying the idleness information; or
a frequency domain resource corresponding to the Y consecutive slots after the slot where the last time domain symbol of the signaling carrying the idleness information is located;
wherein X and Y are natural numbers.

13. A method for determining an idle occasion, wherein the method is performed by a base station, and the method comprises:
sending first signaling to a terminal, wherein the first signaling is used to indicate at least one uplink grant-free transmission resource on a bandwidth part configured by the base station for the terminal; and
according to idleness information, determining an idle occasion released by the terminal from a transmission occasion of the at least one uplink grant-free transmission resource, wherein the idle occasion is for reuse by the base station.

14. The method according to claim 13, further comprising:
receiving Uplink Control Information (UCI) or Radio Resource Control signaling sent by the terminal, wherein the UCI or the RRC signaling comprises the idleness information; or
receiving the idleness information sent by the terminal through a Physical Uplink Shared Channel (PUSCH).

15. The method according to claim 13, wherein the method comprises:
sending the idleness information to the terminal through RRC signaling or Downlink Control Information (DCI).

16. The method according to claim 13, wherein the idleness information comprises an occasion indication field, and the occasion indication field is used to indicate the number M of idle occasions in the transmission occasion.

17. A terminal, comprising:
a processor; and
a memory configured to store instructions executable by the processor;
wherein when the instructions are executable by the processor, the terminal is caused to:
receive first signaling sent by a base station, wherein the first signaling is used to indicate at least one uplink grant-free transmission resource on a bandwidth part configured by the base station for the terminal; and
according to idleness information, determine an idle occasion released from a transmission occasion of the at least one uplink grant-free transmission resource, wherein the idle occasion is for reuse by the base station.

18. A non-transitory computer-readable storage medium having computer program instructions stored thereon, wherein when the program instructions are executed by a processor, the method according to claim 1 is implemented.

19. A base station, comprising:
a processor; and
a memory configured to store instructions executable by the processor;
wherein when the instructions are executable by the processor, the base station is caused to perform the method according to claim 14.

20. A non-transitory computer-readable storage medium having computer program instructions stored thereon, wherein when the program instructions are executed by a processor, the method according to claim 14 is implemented.
